(19) United States
(12) Patent Application Publication
(10) Pub. No.: US 2006/0231653 A1
(43) Pub. Date: Oct. 19, 2006

(54) Vertical symmetrical vibrating mill

(76) Inventor: Felix Arturo Gomez, Bogota (CO)

Correspondence Address: KENYON & KENYON LLP, ONE BROADWAY, NEW YORK, NY, 10004, US

(21) Appl. No.: 10/551,881

(22) PCT Filed: Feb. 19, 2004
(86) PCT No.: PCT/IB04/00533

§ 371 Date: Sep. 30, 2005

(51) Int. Cl. B02C 17/08

(52) U.S. Cl. 241/175

(57) ABSTRACT

A vertical symmetrical vibrating mill that includes a top vibrating tube and a bottom vibrating tube. The top vibrating tube and the bottom vibrating tube are connected so as to form a single vibrating body. The single vibrating body is supported and/or suspended by a support element. The top vibrating tube and the bottom vibrating tube are located on opposite sides of, and are substantially symmetrical about, a reference plane of symmetry. The top vibrating tube and the bottom vibrating tube each have a common axis that is perpendicular to the reference plane of symmetry. In operation, the vibrating mill is preferably arranged such that the common axis of the top vibrating tube and the bottom vibrating tube is oriented in a direction corresponding to the direction of gravity. The vertical symmetrical vibrating mill also includes a plurality of exciter elements including at least one exciter element connected to each of the top vibrating tube and the bottom vibrating tube. Each one of the exciter elements is configured to cause an excitation of the vibrating tubes in a direction that is substantially tangential to the vibrating tubes. Each one of the exciter elements is configured to at least one revolve and oscillate at the same synchronized frequency. An amount of power that is provided to each one of the exciter elements is directly proportional to a distance between the exciter element and the reference plane of symmetry.

### FIELD OF THE INVENTION

The present invention relates to a vertical symmetrical vibrating mill, and more particularly, to a vertical symmetrical vibrating mill that is symmetrically arranged about a reference plane of symmetry.

### BACKGROUND

Vibration devices that may be used transport, compact, clean, polish and classify materials are well known. Recently, vibration devices have also been employed in the field of mechano-chemistry. This field includes mechanical processes, such as mechano-activation or mechano-synthesis, that cause chemical changes in the behavior of certain materials.

Conventional vibration devices typically include chambers that are filled with grinding media and that are supported over springs and/or shock absorbers. The conventional vibration devices are subjected to vibration via vibrating components. Upon the chambers being caused to vibrate, materials that are placed in the chamber are acted upon by the vibrating grinding media, and the impact and frictional forces exerted by the grinding media on the materials cause the materials to be ground, pulverized, mechano-activated, etc.

The quality and nature of the ground material, e.g., size distribution, types of surfaces, particle distribution, etc., depends on various different factors. For instance, some of these factors may be the type of material being ground, the hardness of the grinding media, the intensity and direction of the applied vibration forces, the duration of the grinding process, the chemical composition of any agents which are add many other possible factors.

There are various different types of vibration devices presently employed. For instance, U.S. Pat. No. 2,882,024 describes a non-symmetrical vibration device for pulverizing granular materials. This vibration device is supported circularly by springs and has a vibration element located in the center of a container. A similar device, which employs the same principles but for providing superficial treatment of materials is described in U.S. Pat. No. 4,161,848.

Another conventional vibration device is described in U.S. Pat. No. 2,760,729. Specifically, there is described a multiple-chamber, horizontally-disposed vibration mill in which a circular vibration is imparted by an eccentric axle that is caused to rotate by an externally-coupled motor. Another conventional vibration device is described in German Patent No. DE 3,442,499. In this reference, there is described a vibration device that consists of three horizontal chambers that obtain the circular vibration energy by means of an axle with counterweights located in the center of an equilateral triangle and having in its vertices the cylindrical chambers. U.S. Pat. No. 5,570,848 describes a single cylindrical tube with various chambers and various lateral vibratory motors which impart linear, circular and elliptical movements to the grinding media.

Other conventional vibration devices may include a vertical arrangement. For instance, U.S. Pat. No. 2,922,588 describes a vertically-arranged, asymmetrical vibration mill that is used for the treatment of fibers in aqueous suspension. U.S. Pat. No. 3,687,379 also describes a vertically-arranged, asymmetrical vibration mill that utilizes hammers and anvils as the grinding media in various chambers. In this reference, the vibration forces are provided externally by exciters coupled to the vibration tube.

However, these and other conventional vibration devices do not satisfactorily grind materials, nor do they operate in a satisfactorily efficient manner.

Thus, there is a need for an improved vibration device.

### SUMMARY

The present invention, according to various embodiments thereof, relates to a vertical symmetrical vibrating mill. The vertical symmetrical vibrating mill includes a top vibrating tube and a bottom vibrating tube. The top vibrating tube and the bottom vibrating tube are connected so as to form a single vibrating body. The single vibrating body is supported and/or suspended by a support element. The top vibrating tube and the bottom vibrating tube are located on opposite sides of, and are substantially symmetrical about, a reference plane of symmetry. The top vibrating tube and the bottom vibrating tube each have a common axis that is perpendicular to the reference plane of symmetry. In operation, the vibrating mill is preferably arranged such that the common axis of the top vibrating tube and the bottom vibrating tube is oriented in a direction corresponding to the direction of gravity.

The vertical symmetrical vibrating mill also includes a plurality of exciter elements including at least one exciter element connected to each of the top vibrating tube and the bottom vibrating tube. Each one of the exciter elements is configured to cause an excitation of the vibrating tubes in a direction that is substantially tangential to the vibrating tubes. Advantageously, each one of the exciter elements is configured to at least one revolve and oscillate at the same synchronized frequency. Preferably, an amount of power that is provided to each one of the exciter elements is directly proportional to a distance between the exciter element and the reference plane of symmetry.

In one embodiment, the vertical symmetrical vibrating mill is arranged such that the frequency at which each one of the plurality of exciter elements is configured to vibrate, such as by revolving and/or oscillating, is constant. In another embodiment, the vertical symmetrical vibrating mill is arranged such that the frequency at which each [symbol] plurality of exciter elements is configured to vibrate, such as by revolving and/or oscillating, is variable. The exciter elements may be grouped, such as in pairs or in sets, which preferably are located in planes that are parallel to the reference plane of symmetry. In addition, each of the top and bottom vibrating tubes may include pairs and/or sets of exciter elements, such that corresponding pairs and/or sets of exciter elements are located in planes located on opposite sides of, and located equidistantly from, the reference plane of symmetry. In addition, the exciter elements may be aligned relative to each other on one or both sides of the reference plane of symmetry. Alternatively, the exciter elements may be misaligned relative to each other on one or both sides of the reference plane of symmetry. Still further, the exciter elements may be spaced equidistantly around the circumference of the top and bottom vibrating tubes.

### BRIEF DESCRIPTION OF THE DRAWINGS

FIG. 1 is a side view that illustrates a vertical symmetrical vibrating mill in accordance with one embodiment of the present invention;

FIG. 1(b) is a side view of a connection arrangement of a bottom vibrating tube and a top vibrating tube for the vertical symmetrical vibrating mill illustrated in FIG. 1;

FIG. 2 is a perspective view of the vertical symmetrical vibrating mill illustrated in FIG. 1;

FIG. 3 is a side cross-sectional view of a vertical symmetrical vibrating mill, in accordance with one embodiment of the present invention;

FIG. 4 is a perspective view of an exciter element, in accordance with one embodiment of the present invention;

FIG. 5 is a perspective view of an exciter element, in accordance with one embodiment of the present invention;

FIG. 6 is a perspective view of an exciter element, in accordance with another embodiment of the present invention;

FIG. 7 illustrates a grid, in accordance with one embodiment of the present invention;

FIG. 8 is a partial perspective view of a vertical symmetrical vibrating mill, in accordance with one embodiment of the present invention;

FIG. 9 is a top view of the top vibrating tube of the vertical symmetrical vibrating mill shown in FIG. 11, taken along lines 9-9;

FIG. 10 is a cross-sectional view of the bottom vibrating tube of the vertical symmetrical vibrating mill shown in FIG. 11, taken along the lines 10-10;

FIG. 11 is a side view of the vertical symmetrical vibrating mill illustrated in FIG. 8;

FIG. 12 is a partial perspective view of a vertical symmetrical vibrating mill, in accordance with one embodiment of the present invention;

FIG. 13 is a top view of the top vibrating tube of the vertical symmetrical vibrating mill shown in FIG. 14, taken along lines 13-13;

FIG. 14 is a side view of the vertical symmetrical vibrating mill illustrated in FIG. 12;

FIG. 15 is a partial perspective view of a vertical symmetrical vibrating mill, in accordance with one embodiment of the present invention;

FIG. 16 is a top view of the top vibrating tube of the vertical symmetrical vibrating mill shown in FIG. 17, taken along lines 16-16;

FIG. 17 is a side view of the vertical symmetrical vibrating mill illustrated in FIG. 15;

FIG. 18 is a partial perspective view of a vertical symmetrical vibrating mill, in accordance with one embodiment of the present invention;

FIG. 19 is a top view of the top vibrating tube of the vertical symmetrical vibrating mill shown in FIG. 21, taken along lines 19-19;

FIG. 20 is a cross-sectional view of the bottom vibrating tube of the vertical symmetrical vibrating mill shown in FIG. 21, taken along lines 20-20;

FIG. 21 is a side view of the vertical symmetrical vibrating mill illustrated in FIG. 18;

FIG. 22 is a partial perspective view of a vertical symmetrical vibrating mill, in accordance with one embodiment of the present invention;

FIG. 23 is a top view of the top vibrating tube of the vertical symmetrical vibrating mill shown in FIG. 25, taken along lines 23-23;

FIG. 24 is a cross-sectional view of the bottom vibrating tube of t [symbol] symmetrical vibrating mill shown in FIG. 25, taken along lines 24-24;

FIG. 25 is a side view of the vertical symmetrical vibrating mill illustrated in FIG. 22;

FIG. 26 illustrates a power supply arrangement, in accordance with one embodiment of the present invention, for a vertical symmetrical vibrating mill that employs electric motors to actuate the exciter elements;

FIG. 27 illustrates a power supply arrangement, in accordance with another embodiment of the present invention, for a vertical symmetrical vibrating mill that employs hydraulic motors to actuate the exciter elements;

FIG. 28 illustrates a power supply arrangement, in accordance with still another embodiment of the present invention, for a vertical symmetrical vibrating mill that employs pneumatic motors to actuate the exciter elements;

FIG. 29 is a diagram that illustrates a cone that is representative of a pendular distribution of constant frequency, in accordance with one embodiment of the present invention;

FIG. 30 is a diagram that illustrates a pseudo-cone that is representative of a pendular distribution of variable frequency, in accordance with one embodiment of the present invention;

FIG. 31 is a diagram that illustrates a pseudo-cone that is representative of a pendular distribution of variable frequency as shown in three planes, in accordance with one embodiment of the present invention; and

FIG. 32 is a diagram that illustrates the relative amounts of power [symbol] various vibrating planes, in accordance with various embodiments of the present invention.

### DETAILED DESCRIPTION

The present invention, according to various embodiments thereof, relates to a vertical symmetrical vibrating mill for grinding or pulverizing materials, such as dry materials, or reducing materials in an aqueous solution, e.g., to nanoparticles. For example, the vertical symmetrical vibrating mill of the present invention may be employed in the production of concrete, or any other type of product that is required to be ground, pulverized, reduced, etc.

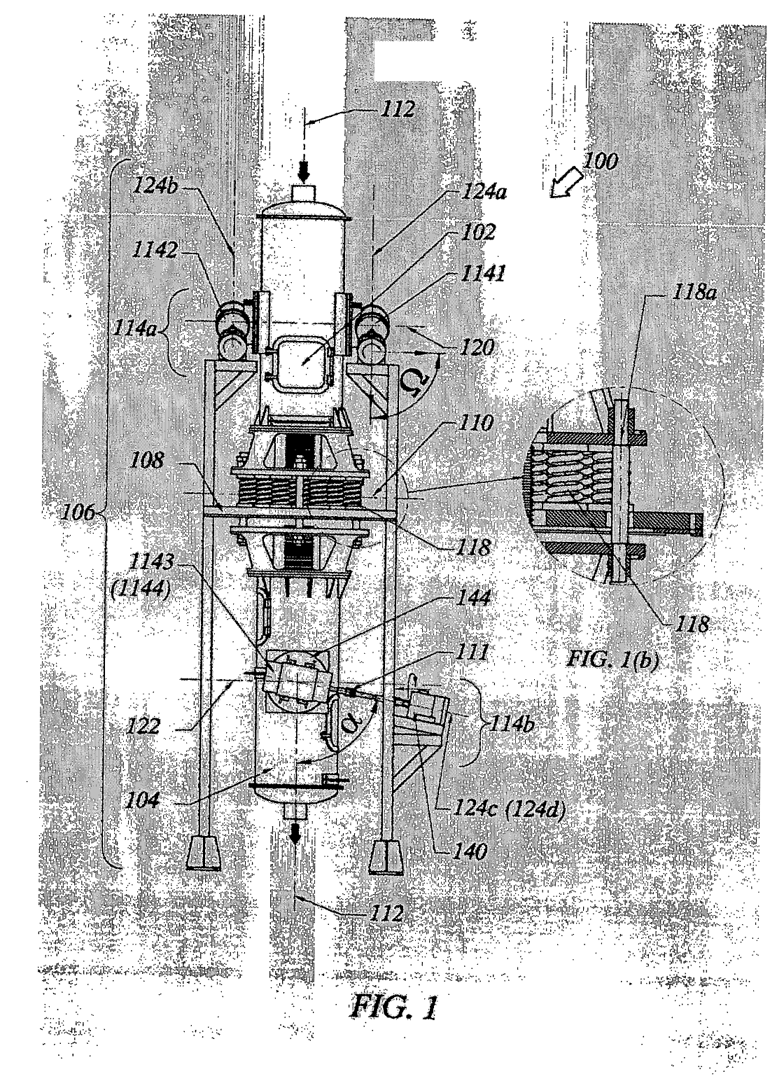

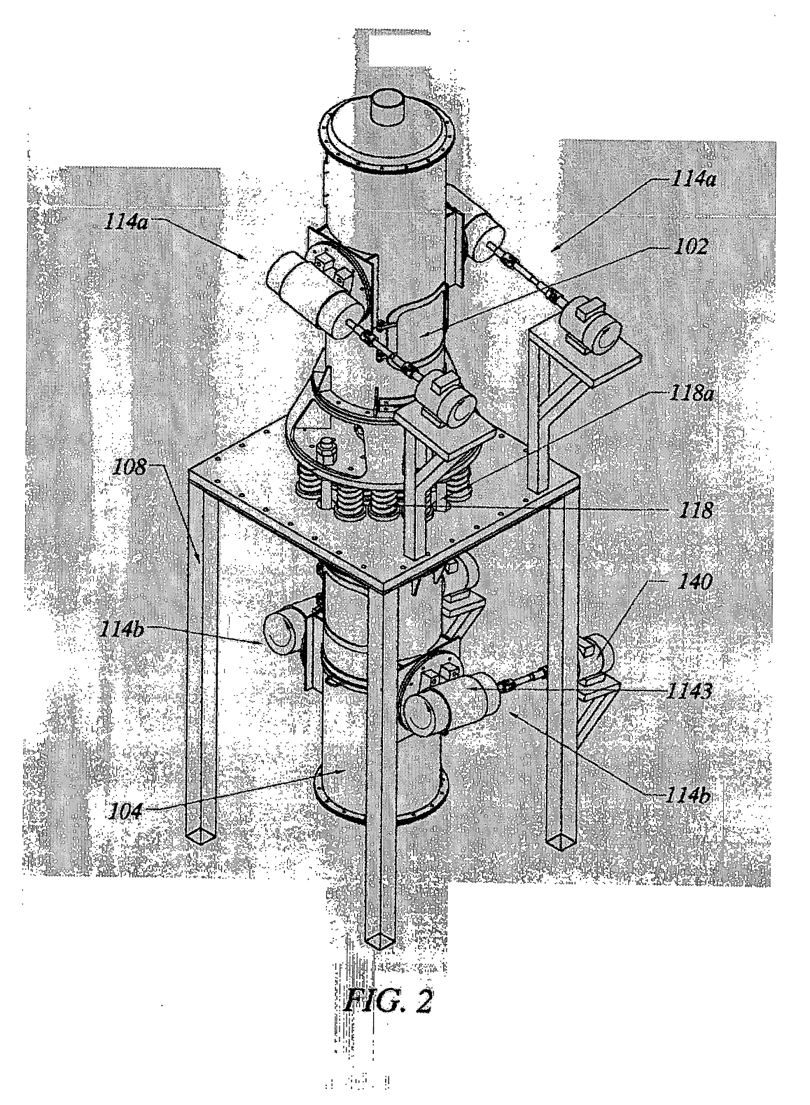

FIG. 1 illustrates a vertical symmetrical vibrating mill in accordance with one embodiment of the present invention. Specifically, FIG. 1 is a side view of a vertical symmetrical vibrating mill 100. FIG. 2, on the other hand, is a perspective view of the vertical symmetrical vibrating mill 100 illustrated in FIG. 1. The vertical symmetrical vibrating mill 100 includes a top vibrating tube 102 and a bottom vibrating tube 104. The top vibrating tube 102 and the bottom vibrating tube 104 are connected to each other by, e.g., connection rods 118a, so as to form a single vibrating body 106. The single vibrating body 106 is supported by a support element 108. Advantageously, the support element 108 and the single vibrating body 106 are configured such that a portion of the single vibrating body 106 is supported by the support element 108 and a portion of the single vibrating body 106 is suspended by the support element 108. For instance, in a preferred embodiment, the support element 108 and the single vibrating body 106 are configured such that the top vibrating tube 102 is supported above the support element 108 and the bottom vibrating tube 104 is suspended below the support element 108.

The support element 108 may include a damping element 118, e.g., a set of springs and/or a set of elastomeric isolators, for damping the transmission of the vibrations to the support element 108. In one embodiment, the damping element 118 may be located within an outer circumference of the single vibrating body 106. In another embod [symbol] damping element 118 may be located outside of an outer circumference of the single vibrating body 106. FIG. 1(b) is a side view of a connection arrangement of a bottom vibrating tube and a top vibrating tube for the vertical symmetrical vibrating mill illustrated in FIG. 1.

As shown in FIG. 1, the vertical symmetrical vibrating mill 100 also defines a reference plane of symmetry 110. The reference plane of symmetry 110 is defined as a plane whereby the top vibrating tube 102 and the bottom vibrating tube 104 are located, e.g., symmetrically disposed, on opposite sides of the reference plane of symmetry 110. FIG. 1 illustrates that the top vibrating tube 102 is located above the reference plane of symmetry 110, while the bottom vibrating tube 104 is located below the reference plane of symmetry 110, and that the top vibrating tube 102 and the bottom vibrating tube 104 are substantially symmetrical with respect to each other about the reference plane of symmetry 110.

In addition, the top vibrating tube 102 and the bottom vibrating tube 104 each define a longitudinal axis. Advantageously, the longitudinal axes defined by each one of the top vibrating tube 102 and the bottom vibrating tube 104 are coaxial so as to define a common axis, e.g., common axis 112, that is perpendicular to the reference plane of symmetry 110. During operation, the vertical symmetrical vibrating mill 100 is preferably situated such that the common axis 112 of the top vibrating tube 102 and the bottom vibrating tube 104 is oriented in a direction corresponding to the direction of gravity.

The vertical symmetrical vibrating mill 100 also includes a plurality of exciter elements 114. In one embodiment, the vertical symmetrical vibrating mill 100 includes at least one exciter element 114 connected, e.g., connected laterally, to the top vibrating tube 102 and at least one exciter element 114 connected, e.g., connected laterally, to the bottom vibrating tube 104. Preferably, however, the vertical symmetrical vibrating mill 100 includes at least a pair 114a of exciter elements 1141, 1142 connected to the to [symbol] tube 102 and at least a pair 114b of exciter elements 1143, 1144 connected to the bottom vibrating tube 104. Each one of the exciter elements 114 is configured to cause an excitation, e.g., a movement or vibration, in a direction or about an excitation axis that is substantially tangential to the vibrating tubes 102, 104. For instance, in the embodiment shown in FIG. 1, each one of the exciter elements 114 is connected at one end to an outer wall of the top vibrating tube 102 and the bottom vibrating tube 104, respectively, and at the other end to the support element 108 such that the exciter elements 114 cause excitation of the top vibrating tube 102 and the bottom vibrating tube 104, respectively, in a direction that is substantially tangential to the vibrating tubes 102, 104.

Various types of exciter elements 114 may be employed. In one embodiment, the exciter elements 114 are be configured to cause an excitation by revolving. In another embodiment, the exciter elements 114 are be configured to cause an excitation by oscillating. The exciter elements 114 may be electromagnetic vibrators. Preferably, each of the exciter elements 114 move at the same synchronized frequency. In other words, each one of the pair 114a of exciter elements 1141, 1142 is synchronized with each other so as to move at the same frequency, and each one of the pair 114b of exciter elements 1143, 1144 is synchronized with each other so as to move at the same frequency. In addition, the exciter elements 1141, 1142 connected to the top vibrating tube 102 and the exciter elements 1143, 1144 connected to the bottom vibrating tube 104 may also be synchronized with each other so as to each move at the same frequency. In one embodiment, the frequency at which each one of the plurality of exciter elements 114 moves is a constant frequency. In other embodiments, the frequency at which each one of the plurality of exciter elements 114 moves is a variable frequency.

In one embodiment of the present invention, and as shown in FIG. 1, the vertical symmetrical vibrating mill 100 may be arranged such that each one of a pair of exciter elements 114 is spaced equidistantly relative to the other exciter element 114 of the pair, around the circumference of the respective vibrating tube 102, 104. For instal [symbol] pair 114a, the exciter elements 1141, 1142 are spaced equidistantly relative to each other around the circumference of the top vibrating tube 102. Likewise, in the pair 114b, the exciter elements 1143, 114A are spaced equidistantly relative to each other around the circumference of the bottom vibrating tube 104.

Additionally, in one embodiment of the present invention, and as shown in FIG. 1, the vertical symmetrical vibrating mill 100 may be arranged such that the exciter elements 114 are located in planes that are parallel to the reference plane of symmetry 110. For instance, in the pair 114a, the exciter elements 1141, 1142 are located in a plane 120 that is parallel to the reference plane of symmetry 110. Likewise, in the pair 114b, the exciter elements 1143, 1144 are located in a plane 122 that is parallel to the reference plane of symmetry 110.

Advantageously, the vertical symmetrical vibrating mill 100 is arranged such that a distance between the plane that includes a first pair of exciter elements connected to the top vibrating tube and the reference plane of symmetry is equal to, or at least substantially equal to, a distance between the plane including a second pair of exciter elements connected to the bottom vibrating tube and the reference plane of symmetry. For instance, as shown in FIG. 1, the distance between the plane 120 that includes the first pair 114a of exciter elements 1141, 1142 and the reference plane of symmetry 110 is equal to a distance between the plane 122 that includes the second pair 114b of exciter elements 1143, 1144 and the reference plane of symmetry 110.

Power is supplied to each one of the exciter elements 114 in order for the exciter elements 114 to operate. In one embodiment of the invention, the power supplied to each one of the exciter elements 114 corresponds to a distance between the exciter element 114 and the reference plane of symmetry 110. For instance, the power supplied to each one of the exciter elements 114 may be directly proportional to a distance between the exciter element 114 and the reference plane of symmetry 110. Furthermore, t [symbol] symmetrical vibrating mill 100 may be arranged such that equal power is supplied to corresponding exciter elements 114, e.g., exciter elements that are located on opposite sides of the reference plane of symmetry 110 and that are located at the same distance from the reference plane of symmetry 110. It should be recognized that, in other embodiments, the power supplied to each one of the exciter elements 114 may not correspond to a distance between the exciter element 114 and the reference plane of symmetry 110, but may be equal or may differ from each other in accordance with a different arrangement.

The vertical symmetrical vibrating mill 100 may be arranged such that an axis of rotation of the exciter elements 114 define an angle a between 0° to 180° relative to a plane that runs through the common axis 112 of the top vibrating tube 102 and the bottom vibrating tube 104. Thus, the vertical symmetrical vibrating mill 100 may be arranged such that the axis of rotation 124a, 124b of the exciter elements 1141, 1142 of the top vibrating tube 102 define an angle between 0° to 180° relative to a plane that runs through the common axis 112 of the top vibrating tube 102. Likewise, the vertical symmetrical vibrating mill 100 may be arranged such that the axis of rotation 124c, 124d of the exciter elements 1143, 1144 of the bottom vibrating tube 104 define an angle between 0° to 180° relative to a plane that runs through the common axis 112 of the bottom vibrating tube 104. In the embodiment shown, the vertical symmetrical vibrating mill 100 is arranged such that the axis of rotation 124a, 124b of the exciter elements 1141, 1142 of the top vibrating tube 102, as well as the axis of rotation 124c, 124d of the exciter elements 1143, 1144 of the bottom vibrating tube 104, define an angle of approximately 80° relative to the plane that runs through the common axis 112. Preferably, the vertical symmetrical vibrating mill 100 is arranged such that the axis of rotation 124a, 124b of the exciter elements 1141, 1142 of the top vibrating tube 102 relative to the plane that runs through the common axis 112 is equal to the axis of rotation 124c, 124d of the exciter elements 1143, 1144 of the bottom vibrating tube 104 relative to the plane that runs through the common axis 112. [symbol] in other embodiments, the vertical symmetrical vibrating mill 100 may be arranged such that the axis of rotation 124a, 124b of the exciter elements 1141, 1142 of the top vibrating tube 102 relative to the plane that runs through the common axis 112 is not equal to the axis of rotation 124c, 124d of the exciter elements 1143, 1144 of the bottom vibrating tube 104 relative to the plane that runs through the common axis 112.

The exciter elements 114 may all rotate in the same direction, e.g., clockwise or counter-clockwise, relative to each other or some of the exciter elements may rotate in opposite directions relative to each other. Preferably, however, each exciter elements 114 that is located on a particular side of the reference plane of symmetry 110 is configured to rotate in the same direction as every other exciter elements 114 that is located on that particular side of the reference plane of symmetry 110. For instance, each one of the exciter elements 1141, 1142, being located above the reference plane of symmetry 110, is configured to rotate in the same direction (clockwise) relative to each other. Likewise, each one of the exciter elements 1143, 1144, being located below the reference plane of symmetry 110, is configured to rotate in the same direction (counter-clockwise) relative to each other. In one embodiment, the vertical symmetrical vibrating mill 100 is arranged such that the exciter elements 1141, 1142 of the top vibrating tube 102 are configured to rotate in the same direction as the exciter elements 1143, 1144 of the bottom vibrating tube 104. Alternatively, in other embodiments, the vertical symmetrical vibrating mill 100 is arranged such that the exciter elements 1141, 1142 of the top vibrating tube 102 are configured to rotate in an opposite direction relative to the exciter elements 1143, 1144 of the bottom vibrating tube 104. In one embodiment, the exciter elements 114 may oscillate between an angle Ω of 0° to 90°.

In one embodiment, the exciter elements 114 of the top vibrating tube 102 are aligned circumferentially with the exciter element 114 of the bottom vibrating tube 104. Alternatively, the exciter elements 114 of the top vibrating tube 102 may be misaligned circumferentially with respect to the exciter element 114 of the bottom vibrating tube 104. For instance, FIG. 2 illustrates that the exciter elements 1141, 1142 of the top vibrating tube 102 are located at the relative circumferential positions of 0° and 180°, a exciter elements 1143, 1144 of the bottom vibrating tube 104 are located at the relative circumferential positions of 90° and 270°. Thus, in this embodiment, the exciter elements 1141, 1142 of the top vibrating tube 102 are misaligned by 90° circumferentially with respect to the exciter elements 1143, 1144 of the bottom vibrating tube 104. However, it should be recognized that, in other embodiments, the exciter elements 1141, 1142 of the top vibrating tube 102 may be circumferentially misaligned with respect to the exciter elements 1143, 1144 of the bottom vibrating tube 104 by other than 90°.

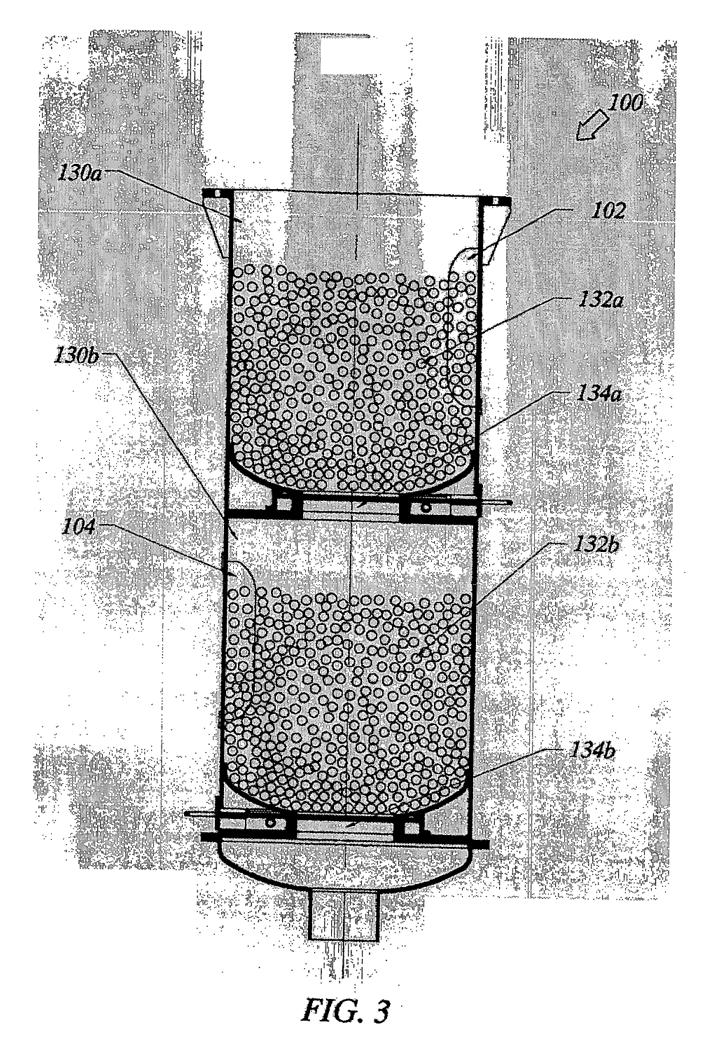

FIG. 3 is a side cross-sectional view of a vertical symmetrical vibrating mill 100, in accordance with one embodiment of the present invention. FIG. 3 illustrates the vertical symmetrical vibrating mill 100, wherein each one of the top vibrating tube 102 and the bottom vibrating tube 104 defines a chamber 130. For instance, the top vibrating tube 102 defines a top chamber 130a, while the bottom vibrating tube 104 defines a bottom chamber 130b. Each chamber 130 stores a grinding media 132 for grinding materials that are placed within the chamber 130. For instance, the top chamber 130a stores a grinding media 132a for grinding materials that are placed within the top chamber 130a, and the bottom chamber 130b stores a grinding media 132b for grinding materials that are placed within the bottom chamber 130b. The grinding media 132 that is stored in the top chamber 130a may be the same as, or different from, the grinding media 132 that is stored in the bottom chamber 130b. In addition, the weight of the grinding media in each of the top chamber 130a and the bottom chamber 130b may be the same.

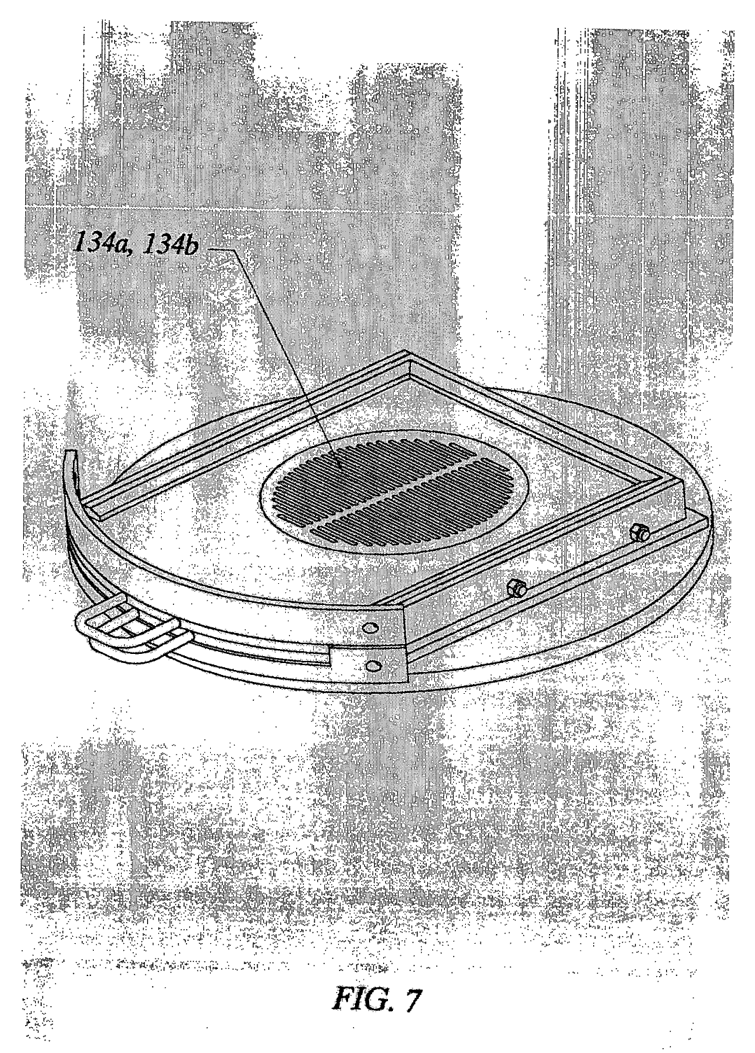

At the bottom of each chamber 130a, 130b are grids 134a, 134b, respectively. FIG. 7 illustrates a grid, such as grids 134a, 134b, in accordance with one embodiment of the present invention. Each grid 134a, 134b defines openings therein that are smaller than the smallest dimension of the grinding media stored in its respective chamber 130a, 130b. For instance, the grid 134a, which is located at the bottom of top chamber 130a, defines openings therein that are smaller than the smallest dimension of the grinding media 132a stored in the top chamber 130a. Likewise, the grid 134b, which is located at the bottom of the bottom chamber 130b, defines openings therein that are smaller than [symbol] dimension of the grinding media 132b stored in the bottom chamber 130b. The grids 134a and 134b may be selectively closable so as to prevent any material from flowing through.

The exciter elements 114 may be actuated by an electric motor 140. For instance, FIG. 4 is a perspective view of an exciter element 114, in accordance with one embodiment of the present invention. FIG. 4 illustrates an exciter element 114 that includes an electric motor 140a that is situated externally with respect to the exciter element 114. As shown, the electric motor 140a and the exciter element 114 are coupled to each other via a connection element 111. FIG. 4 also illustrates an eccentric counterweight 142 which may enable the exciter elements 114, when actuated by the electric motor 140a, to vibrate. The exciter element 114 also includes a mounting bracket 144 for mounting the exciter element 114 to either the top vibrating tube 102 or to the bottom vibrating tube 104.

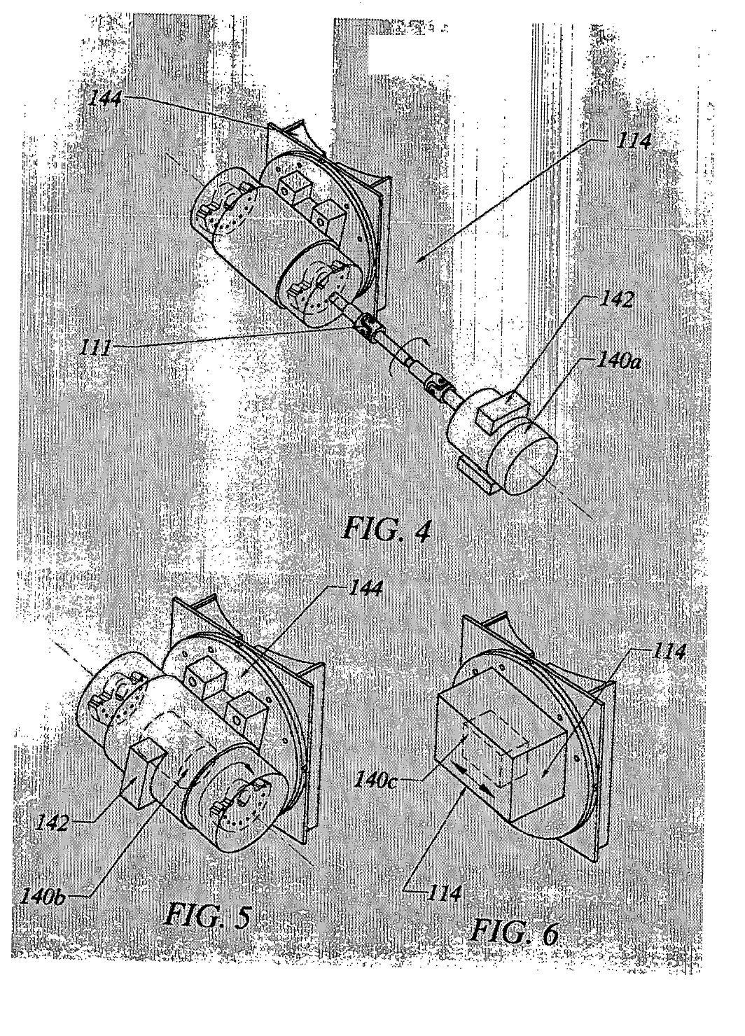

Alternatively, the exciter elements 114 may be actuated by an internally-disposed electric motor 140b. For instance, FIG. 5 is a perspective view of an exciter element 114, in accordance with one embodiment of the present invention, in which the exciter element 114 includes an electric motor 140b that is situated internally with respect to the exciter element 114. FIG. 5 illustrates that the internally-disposed electric motor 140b is configured to cause the exciter element 114 to move, e.g., vibrate, rotatably. FIG. 6, on the other hand, is a perspective view of an exciter element 114, in accordance with one embodiment of the present invention, in which the exciter element 114 includes an electric motor 140c that is situated internally with respect to the exciter element 114, whereby the internally-disposed electric motor 140c is configured to cause the exciter element 114 to move, e.g., vibrate, in linear fashion.

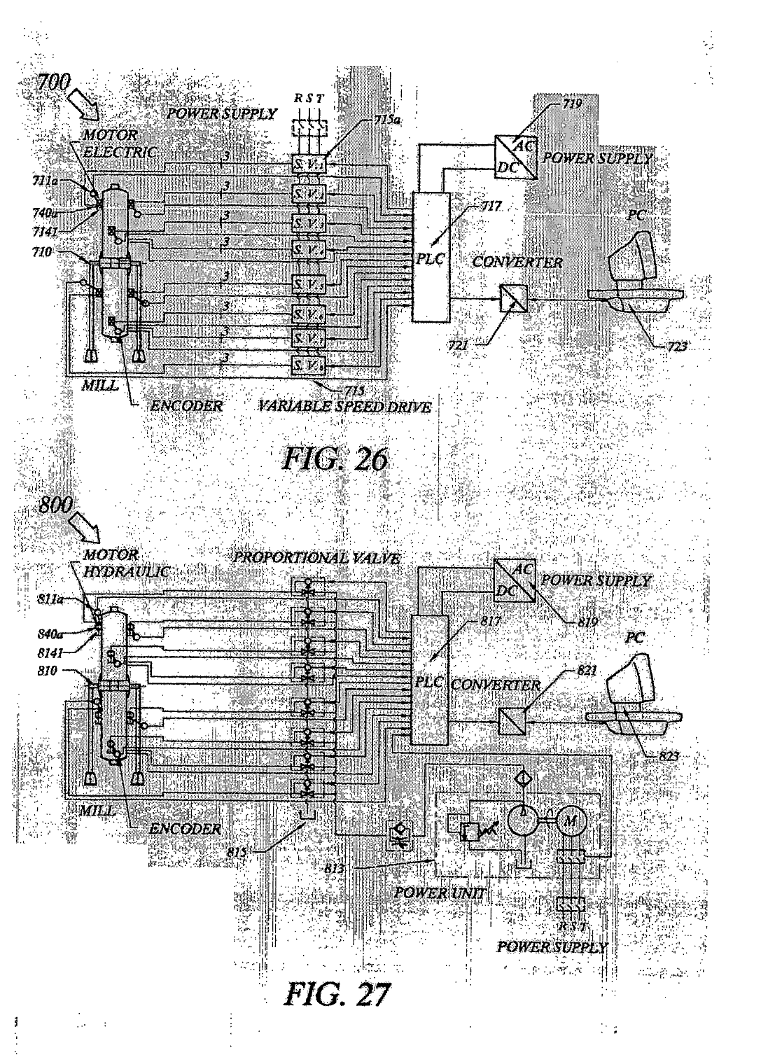

It should be recognized that, while FIGS. 4 to 6 illustrate various embodiments of an exciter element 114 including an electric motor 140, in other embodiments, the exciter elements 114 may be activated by, e.g., a hydraulic motor, a pneumatic motor, etc. Embodiments that employ hydraulic motors and pneumatic motors to actuate [symbol] elements are described in greater detail below, for instance in connection with FIGS. 27 and 28, respectively.

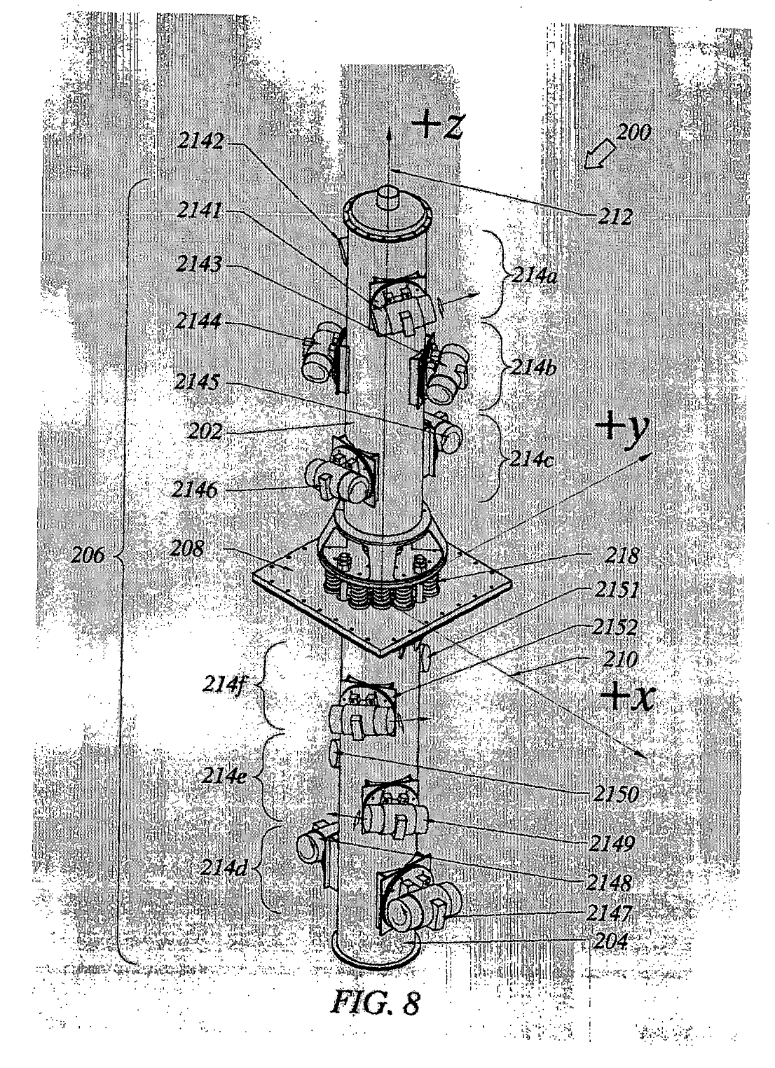

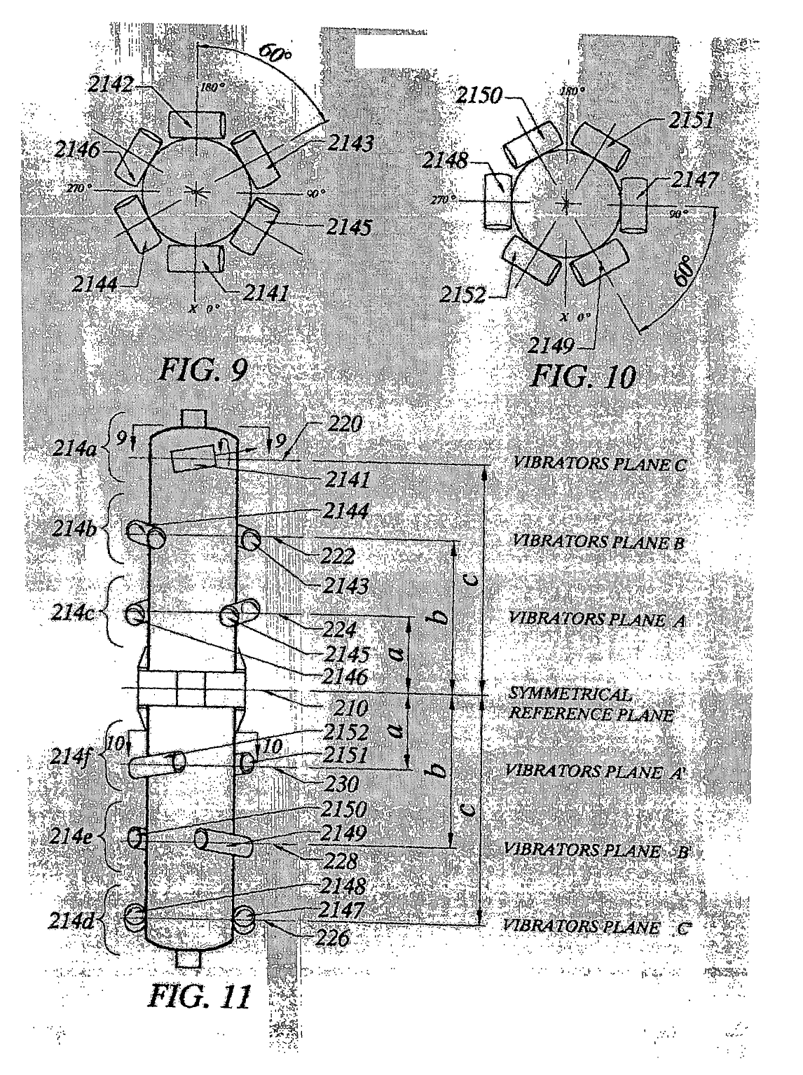

FIGS. 8 to 11 illustrate a vertical symmetrical vibrating mill in accordance with another embodiment of the present invention. Specifically, FIG. 8 is a partial perspective view of a vertical symmetrical vibrating mill 200. FIG. 11, on the other hand, is a side view of the vertical symmetrical vibrating mill 200 illustrated in FIG. 8. The vertical symmetrical vibrating mill 200 includes a top vibrating tube 202 and a bottom vibrating tube 204. The top vibrating tube 202 and the bottom vibrating tube 204 are connected to each other so as to form a single vibrating body 206, which is supported by a support element 208 (partially shown), such as the support element shown in FIG. 1. Advantageously, the support element 208 and the single vibrating body 206 are configured such that the top vibrating tube 202 is supported above the support element 208 and the bottom vibrating tube 204 is suspended below the support element 208. The support element 208 may include a damping element 218, e.g., a set of springs and/or a set of elastomeric isolators, for damping the transmission of the vibrations to the support element 208.

As shown in FIG. 8, the vertical symmetrical vibrating mill 200 also defines a reference plane of symmetry 210. The reference plane of symmetry 210 is a plane whereby the top vibrating tube 202 and the bottom vibrating tube 204 are located, e.g., symmetrically disposed, on opposite sides of the reference plane of symmetry 210. As shown in FIG. 8, the reference plane of symmetry 210 is a plane formed by the +x and +y axes. FIG. 8 illustrates that the top vibrating tube 202 is located above the reference plane of symmetry 210, while the bottom vibrating tube 204 is located below the reference plane of symmetry 210, and that the top vibrating tube 202 and the bottom vibrating tube 204 are substantially symmetrical with respect to each other about the reference plane of symmetry 210.

In addition, the top vibrating tube 202 and the bottom vibrating tube 204 each define a longitudinal axis, shown in FIG. 8 as the +z axis. Advantageously, the longit [symbol] defined by each one of the top vibrating tube 202 and the bottom vibrating tube 204 are coaxial so as to define a common axis, e.g., common axis 212, that is perpendicular to the reference plane of symmetry 210. During operation, the vertical symmetrical vibrating mill 200 is preferably situated such that the common axis 212 of the top vibrating tube 202 and the bottom vibrating tube 204 is oriented in a direction corresponding to the direction of gravity.

The vertical symmetrical vibrating mill 200 includes three pairs 214a, 214b and 214c of exciter elements 214 connected to the top vibrating tube 202, wherein the first pair 214a includes exciter elements 2141 and 2142, the second pair 214b includes exciter elements 2143 and 2144, and the third pair 214c includes exciter elements 2145 and 2146. In addition, the vertical symmetrical vibrating mill 200 includes three pairs 214d, 214e and 214f of exciter elements connected to the bottom vibrating tube 204, wherein the first pair 214d includes exciter elements 2147 and 2148, the second pair 214e includes exciter elements 2149 and 2150, and the third pair 214f includes exciter elements 2151 and 2152. Each one of the exciter elements 214 is configured to cause an excitation, e.g., a movement or vibration, in a direction or about an excitation axis that is substantially tangential to the vibrating tubes 202, 204.

In one embodiment of the invention, the power supplied to each one of the exciter elements 214 corresponds to a distance between the exciter element 214 and the reference plane of symmetry 210. For instance, the power supplied to each one of the exciter elements 214 may be directly proportional to a distance between the exciter element 214 and the reference plane of symmetry 210. Furthermore, the vertical symmetrical vibrating mill 200 may be arranged such that equal power is supplied to corresponding exciter elements 214, e.g., exciter elements that are located on opposite sides of the reference plane of symmetry 210 and that are located at the same distance from the reference plane of symmetry 210. FIG. 32 is a diagram that illustrates the relative amounts of the power supplied to various vibrating planes. As illustrated in FIG. 32, the power supplied to the various vibrating planes may be directly [symbol] proportional to the distance of the vibrating planes to the reference plane of symmetry. Furthermore, the power supplied to the various vibrating planes may be represented as a function in the form of z=f(x), where f(x) may include any function, and thus, may be represented in FIG. 32 as any line, curve, etc.

FIG. 9 is a top view of the top vibrating tube 202 of the vertical symmetrical vibrating mill 200 shown in FIG. 11, taken along lines 9-9. FIG. 10 is a cross-sectional view of the bottom vibrating tube 204 of the vertical symmetrical vibrating mill 200 shown in FIG. 11, taken along the lines 10-10. As shown in FIGS. 9 and 10, the vertical symmetrical vibrating mill 200 may be arranged such that each one of a pair of exciter elements 214 is spaced equidistantly relative to the other exciter element 214 of the pair, around the circumference of the respective vibrating tube 202, 204. For instance, in the pair 214a, the exciter elements 2141 and 2142 are spaced equidistantly relative to each other around the circumference of the top vibrating tube 202, in the pair 214b, the exciter elements 2143 and 2144 are spaced equidistantly relative to each other around the circumference of the top vibrating tube 202, etc.

In addition, the vertical symmetrical vibrating mill 200 may be arranged such that at least some, but preferably all, of the exciter elements 214 are spaced equidistantly relative to the other exciter elements 214 around the circumference of their respective vibrating tube 202, 204. For instance, and as shown in FIG. 9, around the circumference of the top vibrating tube 202, the exciter elements 2141, 2142 of the pair 214a, the exciter elements 2143, 2144 of the pair 214b, and the exciter elements 2145, 2146 of the pair 214c are circumferentially spaced 60 degrees apart. Likewise, and as shown in FIG. 10, around the circumference of the bottom vibrating tube 204, the exciter elements 2147, 2148 of the pair 214d, the exciter elements 2149, 2150 of the pair 214e, and the exciter elements 2151, 2152 of the pair 214e are circumferentially spaced 60 degrees apart.

In one embodiment, the exciter elements 214 of the top vibrating tube 202 are aligned circumferentially with the exciter element 214 of the bottom vibrating Alternatively, the exciter elements 214 of the top vibrating tube 202 may be misaligned circumferentially with respect to the exciter element 214 of the bottom vibrating tube 204. More specifically, the vertical symmetrical vibrating mill 200 may be arranged such that at least some, but preferably all, of exciter elements 214 on one side of the reference plane of symmetry 210 are misaligned relative to the other exciter elements 214 on the other side of the reference plane of symmetry 210 around the circumference of their respective vibrating tube 202, 204. For instance, and as shown in FIG. 9, around the circumference of the top vibrating tube 202, the exciter elements 2141, 2142 of the pair 214a are circumferentially located at 0 and 180 degrees, respectively, the exciter elements 2143, 2144 of the pair 214b are circumferentially located at 120 and 300 degrees, respectively, and the exciter elements 2145, 2146 of the pair 214c are circumferentially located at 60 and 240 degrees, respectively. Likewise, and as shown in FIG. 10, around the circumference of the bottom vibrating tube 204, the exciter elements 2147, 2148 of the pair 214d are circumferentially located at 90 and 270 degrees, respectively, the exciter elements 2149, 2150 of the pair 214e are circumferentially located at 30 and 210 degrees, respectively, and the exciter elements 2151, 2152 of the pair 214e are circumferentially located at 150 and 330 degrees, respectively.

As shown in FIG. 11, the vertical symmetrical vibrating mill 200 is arranged such that the pairs of exciter elements 214 are located in planes that are parallel to the reference plane of symmetry 210. For instance, with respect to the top vibrating tube 202, in the pair 214a, the exciter elements 2141, 2142 are located in a plane 220, while in the pair 214b, the exciter elements 2143, 2144 are located in a plane 222 and in the pair 214c, the exciter elements 2145, 2146 are located in a plane 224. The planes 220, 222 and 224 are each parallel to the reference plane of symmetry 210. Likewise, with respect to the bottom vibrating tube 204, in the pair 214d, the exciter elements 2147, 2148 are located in a plane 226, while in the pair 214e, the exciter elements 2149, 2150 are located in a plane 228, and in the pair 214f, the exciter elements 2151, 2152 are located in a plane 230. The planes 226, 228 and 230 are each parallel to the reference plane of symmetry 210.

Advantageously, the vertical symmetrical vibrating mill 200 is arranged such that the distance between the vibrating planes of the top vibrating tube and the reference plane of symmetry is equal to, or at least substantially equal to, a distance between the vibrating planes of the bottom vibrating tube and the reference plane of symmetry. For instance, as shown in FIG. 11, the distance between the plane 220 that includes the pair 214a of exciter elements 2141, 2142 and the reference plane of symmetry 210 is equal to a distance between the plane 226 that includes the pair 214d of exciter elements 2147, 2148 and the reference plane of symmetry 210. Likewise, the distance between the plane 222 that includes the pair 214b of exciter elements 2143, 2144 and the reference plane of symmetry 210 is equal to a distance between the plane 228 that includes the pair 214e of exciter elements 2149, 2150 and the reference plane of symmetry 210. Furthermore, the distance between the plane 224 that includes the pair 214c of exciter elements 2145, 2146 and the reference plane of symmetry 210 is equal to a distance between the plane 230 that includes the pair 214f of exciter elements 2151, 2152 and the reference plane of symmetry 210.

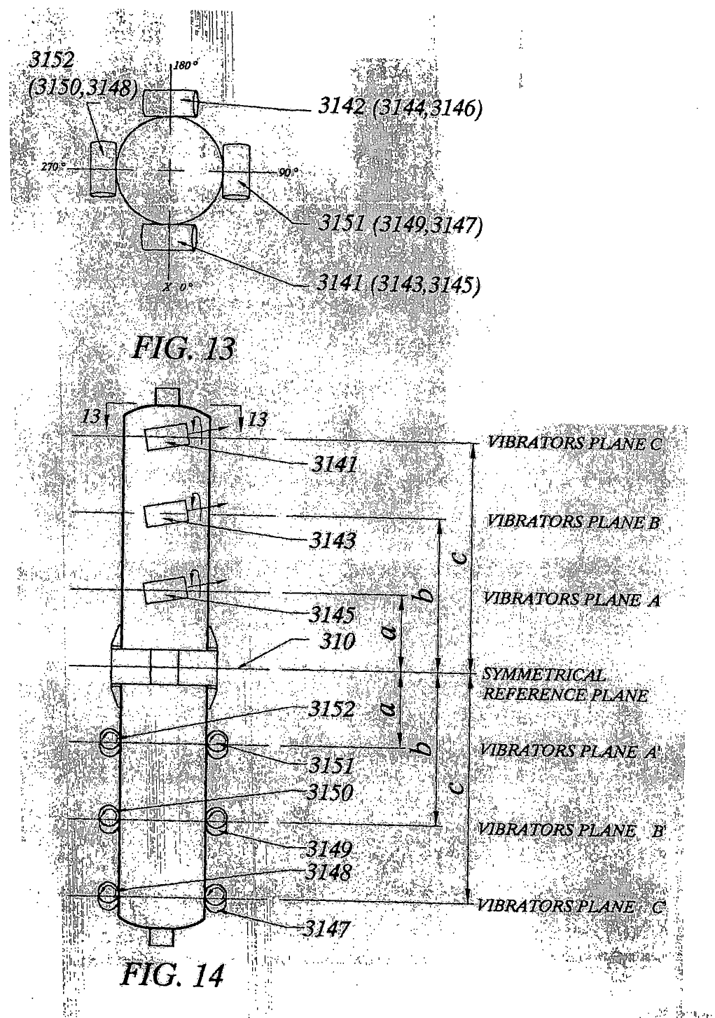

FIGS. 12 to 14 illustrate a vertical symmetrical vibrating mill in accordance with another embodiment of the present invention. Specifically, FIG. 12 is a partial perspective view of a vertical symmetrical vibrating mill 300. FIG. 14, on the other hand, is a side view of the vertical symmetrical vibrating mill 300 illustrated in FIG. 12. The vertical symmetrical vibrating mill 300 includes a top vibrating tube 302 and a bottom vibrating tube 304 that are connected to each other so as to form a single vibrating body 306. The single vibrating body 306 is supported by a support element 308 (shown partially), such as the support element shown in FIG. 1. Advantageously, the support element 308 and the single vibrating body 306 are configured such that the top vibrating tube 302 is supported above the support element 308 and the bottom vibrating tube 304 is suspended below the support element 308. The support element 308 may include a damping element 318, e.g., a set of springs and/or a set of elastomeric isolators, for damping the transmission of the vibrations to the support element 308.

As shown in FIG. 12, the vertical symmetrical vibrating mill 300 also defines a reference plane of symmetry 310 whereby the top vibrating tube 302 and the bottom vibrating tube 304 are located, e.g., symmetrically disposed, on opposite sides of the reference plane of symmetry 310. FIG. 12 illustrates that the top vibrating tube 302 is located above the reference plane of symmetry 310, while the bottom vibrating tube 304 is located below the reference plane of symmetry 310, and that the top vibrating tube 302 and the bottom vibrating tube 304 are substantially symmetrical with respect to each other about the reference plane of symmetry 310.

The vertical symmetrical vibrating mill 300 includes three pairs 314a, 314b and 314c of exciter elements 314 connected to the top vibrating tube 302, wherein the first pair 314a includes exciter elements 3141 and 3142, the second pair 314b includes exciter elements 3143 and 3144, and the third pair 314c includes exciter elements 3145 and 3146. In addition, the vertical symmetrical vibrating mill 300 includes three pairs 314d, 314e and 314f of exciter elements connected to the bottom vibrating tube 304, wherein the first pair 314d includes exciter elements 3147 and 3148, the second pair 314e includes exciter elements 3149 and 3150, and the third pair 314f includes exciter elements 3151 and 3152. Each one of the exciter elements 314 is configured to cause an excitation, e.g., a movement or vibration, in a direction or about an excitation axis that is substantially tangential to the vibrating tubes 302, 304.

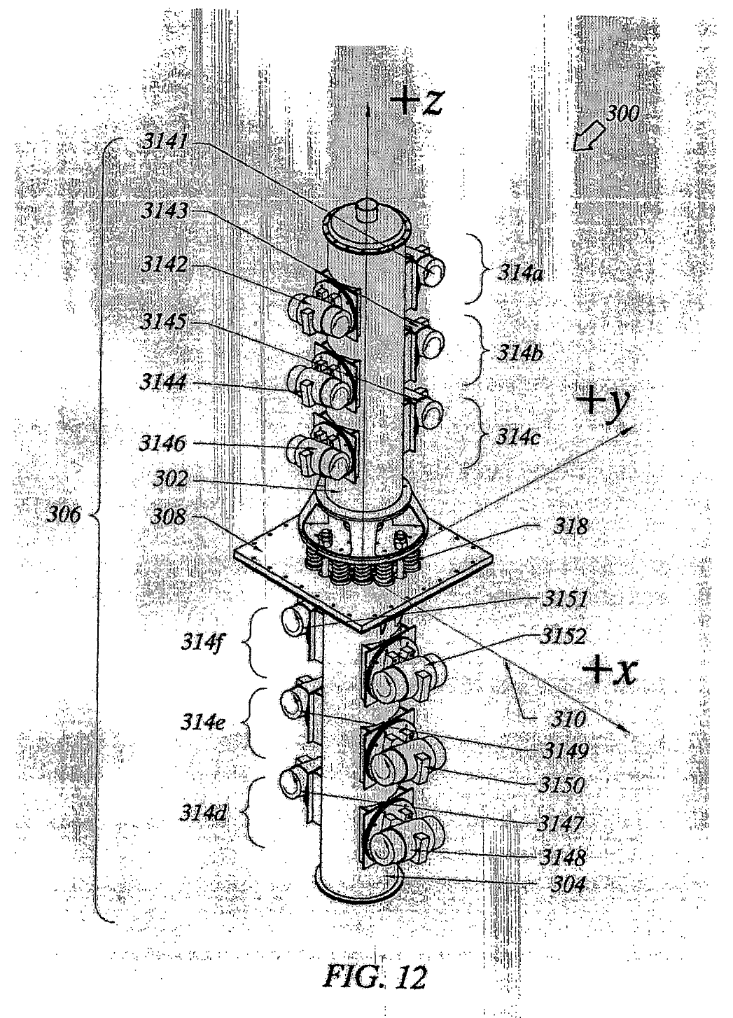

FIG. 13 is a top view of the top vibrating tube 302 of the vertical symmetrical vibrating mill 300 shown in FIG. 14, taken along lines 13-13. As shown in FIGS. 13, the vertical symmetrical vibrating mill 300 may be arranged such that each one of a pair of exciter elements 314 is spaced equidistantly relative to the other exciter element 314 of the pair, around the circumference of the respective vibrating tube 302, 304. For instance, in the pair 314a, the exciter elements 3141, 3142 are spaced equidistantly relative to each other around the circumference of the top vibrating tube 302; in the pair 314b, the exciter elements 3143, 3144 are spaced equidistantly relative to each other around the circumference of the top vibrating tube 302, etc.

In the embodiment shown in FIGS. 12 to 14, each one of the exciter elements 314 of the top vibrating tube 302 is aligned circumferentially with every other exciter element 314 of the top vibrating tube 302. Likewise, each one of the exciter elements 314 of the bottom vibrating tube 304 is aligned circumferentially with every other exciter element 314 of the bottom vibrating tube 304. Still further, FIGS. 12 to 14 illustrate one embodiment in which the exciter elements 314 of the top vibrating tube 302 are misaligned circumferentially with respect to the exciter element 314 of the bottom vibrating tube 304. For instance, and as shown in FIG. 13, around the circumference of the top vibrating tube 302, the exciter elements 3141, 3143 and 3145 are each circumferentially located at 0 degrees, while the exciter elements 3142, 3144 and 3146 are each circumferentially located at 180 degrees. Likewise, and as shown in FIG. 13, around the circumference of the bottom vibrating tube 304, the exciter elements 3147, 3149 and 3151 are each circumferentially located at 90 degrees, while the exciter elements 3148, 3150 and 3152 are each circumferentially located at 270 degrees. It should be recognized that, in other embodiments, the exciter elements 314 may be aligned, or misaligned, in a different arrangement than described above.

In one embodiment of the invention, the power supplied to each one of the exciter elements 314 corresponds to a distance between the exciter element 314 and the reference plane of symmetry 310. For instance, the power supplied to each one of the exciter elements 314 may be directly proportional to a distance between the exciter element 314 and the reference plane of symmetry 310.

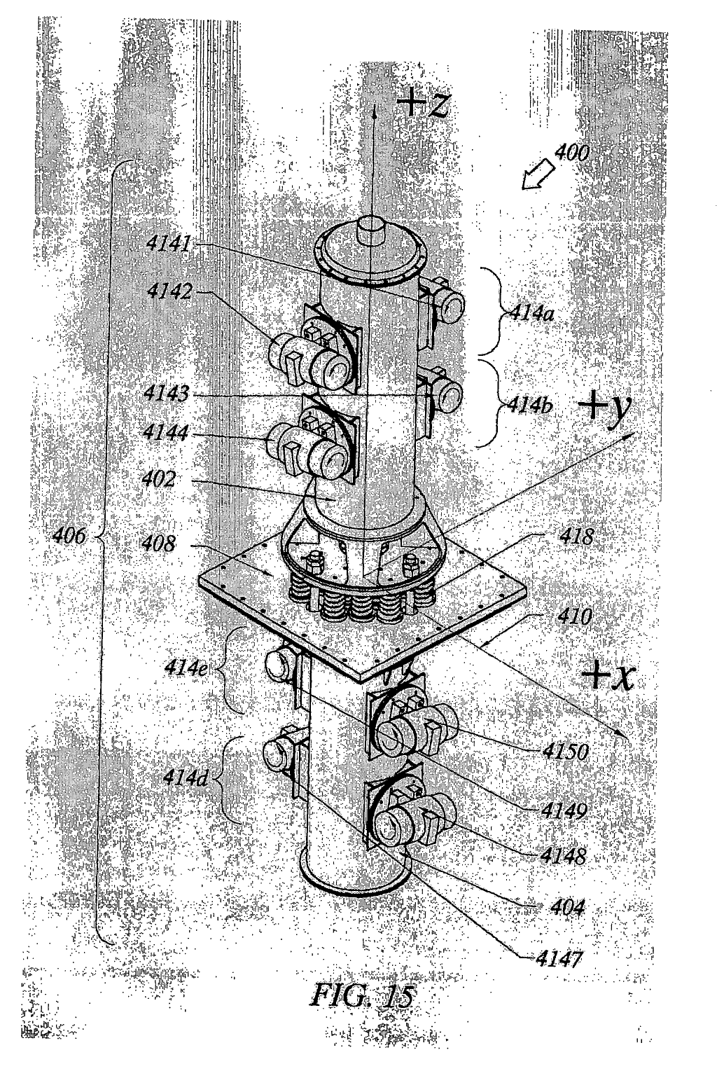

FIGS. 15 to 17 illustrate a vertical symmetrical vibrating mill in accordance with another embodiment of the present invention. Specifically, FIG. 15 is a partial perspective view of a vertical symmetrical vibrating mill 400. FIG. 17, on the other hand, is a side view of the vertical symmetrical vibrating mill 400 illustrated in FIG. 15. The vertical symmetrical vibrating mill 400 includes a top vibrating tube 402 and a bottom vibrating tube 404 that are connected to each other so as to form a single vibr [symbol] 406. The single vibrating body 406 is supported by a support element, such as the support element shown in FIG. 1, but which is shown in FIG. 15 only partially as support element 408. Advantageously, the support element 408 and the single vibrating body 406 are configured such that the top vibrating tube 402 is supported above the support element 408 and the bottom vibrating tube 404 is suspended below the support element 408. The support element 408 may include a damping element 418, e.g., a set of springs and/or a set of elastomeric isolators, for damping the transmission of the vibrations to the support element 408.

As shown in FIG. 15,-the vertical symmetrical vibrating mill 400 also defines a reference plane of symmetry 410 whereby the top vibrating tube 402 and the bottom vibrating tube 404 are located, e.g., symmetrically disposed, on opposite sides of the reference plane of symmetry 410. FIG. 15 illustrates that the top vibrating tube 402 is located above the reference plane of symmetry 410, while the bottom vibrating tube 404 is located below the reference plane of symmetry 410, and that the top vibrating tube 402 and the bottom vibrating tube 404 are substantially symmetrical with respect to each other about the reference plane of symmetry 410.

The vertical symmetrical vibrating mill 400 includes two pairs 414a, 414b of exciter elements 414 connected to the top vibrating tube 402, wherein the first pair 414a includes exciter elements 4141 and 4142 and the second pair 414b includes exciter elements 4143 and 4144. In addition, the vertical symmetrical vibrating mill 400 includes two pairs 414d, 414e of exciter elements connected to the bottom vibrating tube 404, wherein the first pair 414d includes exciter elements 4147 and 4148 and the second pair 414e includes exciter elements 4149 and 4150. Each one of the exciter elements 414 is configured to cause an excitation, e.g., a movement or vibration, in a direction or about an excitation axis that is substantially tangential to the vibrating tubes 402, 404.

FIG. 16 is a top view of the top vibrating tube 402 of the vertical symmetrical vibrating mill 400 shown in FIG. 17, taken along lines 16-16. As shown in Figu [symbol] vertical symmetrical vibrating mill 400 may be arranged such that each one of a pair of exciter elements 414 is spaced equidistantly relative to the other exciter element 414 of the pair, around the circumference of the respective vibrating tube 402, 404. For instance, in the pair 414a, the exciter elements 4141, 4142 are spaced equidistantly relative to each other around the circumference of the top vibrating tube 402 and in the pair 414b, the exciter elements 4143, 4144 are spaced equidistantly relative to each other around the circumference of the top vibrating tube 402.

In the embodiment shown in FIGS. 15 to 17, the exciter elements 414 of the top vibrating tube 402 are aligned circumferentially with other exciter element 414 of the top vibrating tube 402. Likewise, the exciter elements 414 of the bottom vibrating tube 404 are aligned circumferentially with other exciter element 414 of the bottom vibrating tube 404. Still further, in FIGS. 15 to 17, the exciter elements 414 of the top vibrating tube 402 are misaligned circumferentially with respect to the exciter elements 414 of the bottom vibrating tube 404. For instance, and as shown in FIG. 16, around the circumference of the top vibrating tube 402, the exciter elements 4141 and 4143 are each circumferentially located at 0 degrees, while the exciter elements 4142 and 4144 are each circumferentially located at 180 degrees. Likewise, and as shown in FIG. 16, around the circumference of the bottom vibrating tube 404, the exciter elements 4147 and 4149 are each circumferentially located at 90 degrees, while the exciter elements 4148 and 4150 are each circumferentially located at 270 degrees.

In one embodiment of the invention, the power supplied to each one of the exciter elements 414 corresponds to a distance between the exciter element 414 and the reference plane of symmetry 410. For instance, the power supplied to each one of the exciter elements 414 may be directly proportional to a distance between the exciter element 414 and the reference plane of symmetry 410.

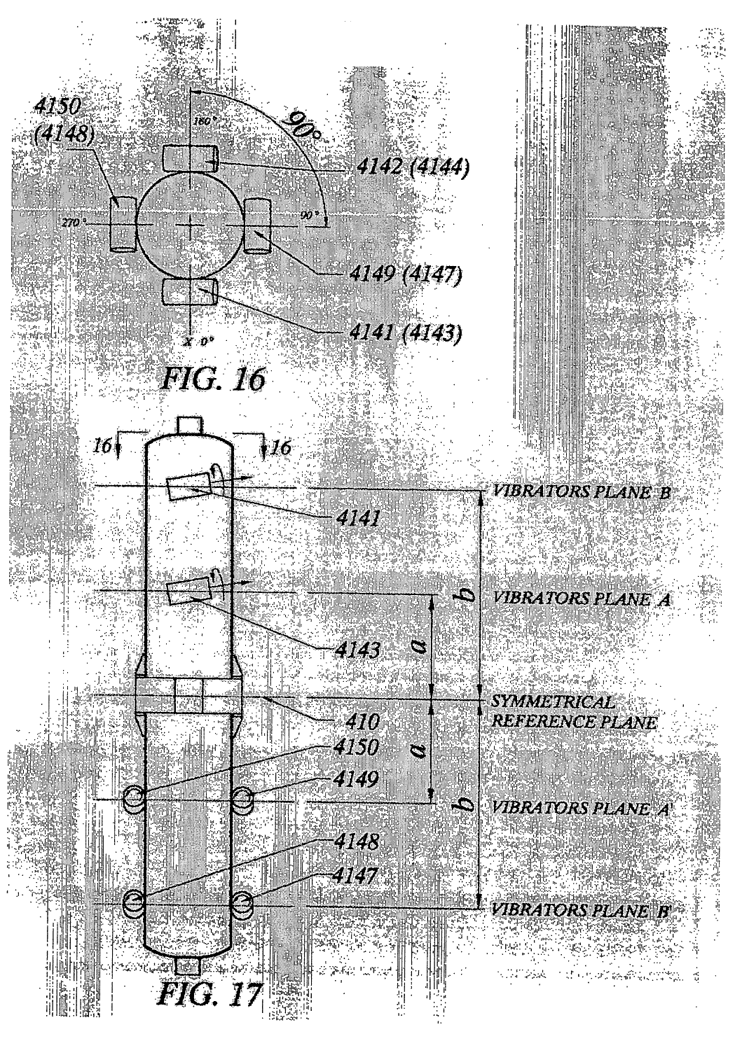

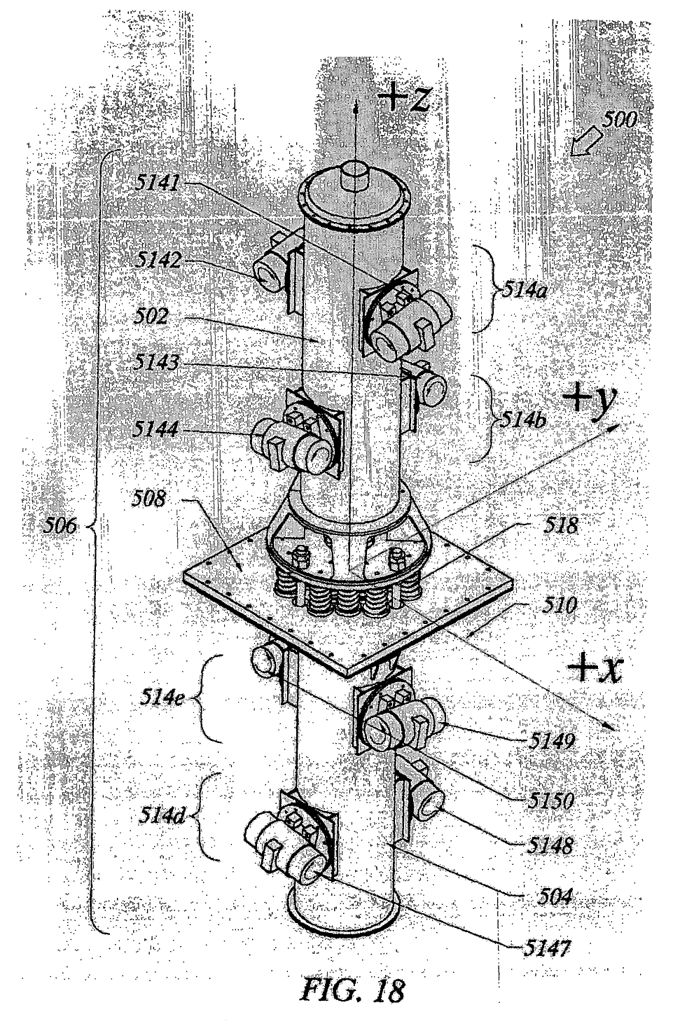

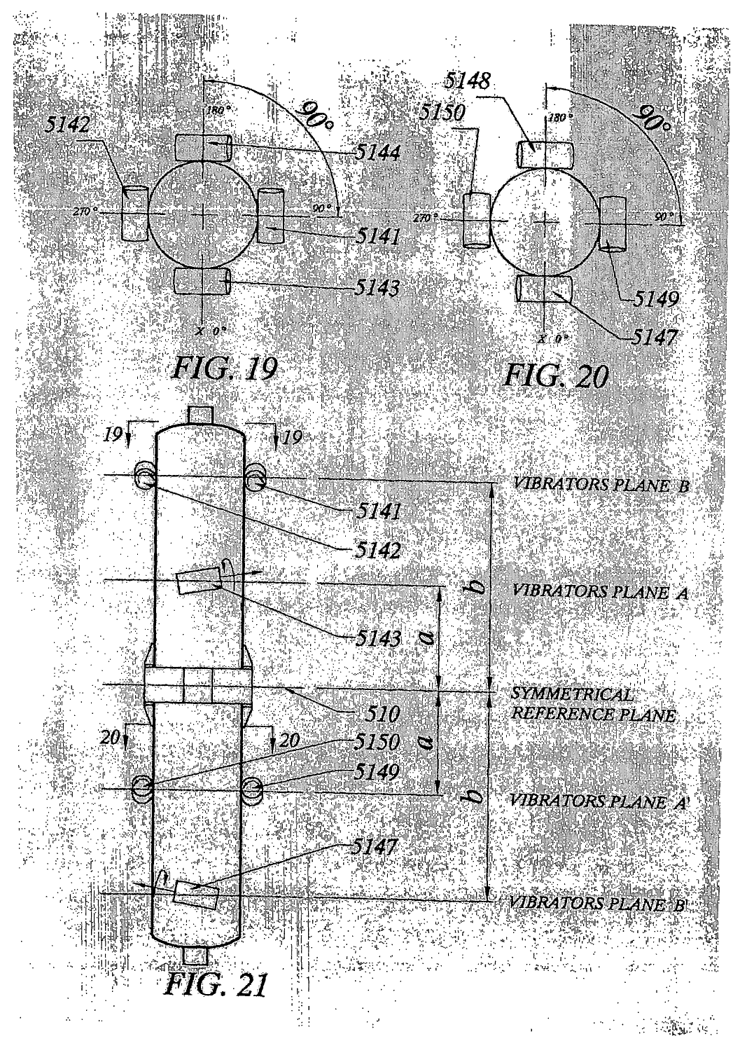

FIGS. 18 to 21 illustrate a vertical symmetrical vibrating mill in accordance with another embodiment of the present invention. Specifically, FIG. 18 is [symbol] perspective view of a vertical symmetrical vibrating mill 500. FIG. 21, on the other hand, is a side view of the vertical symmetrical vibrating mill 500 illustrated in FIG. 18. The vertical symmetrical vibrating mill 500 includes a top vibrating tube 502 and a bottom vibrating tube 504 that are connected to each other so as to form a single vibrating body 506. The single vibrating body 506 is supported by a support element 508 (partially shown), such as the support element shown in FIG. 1. Advantageously, the support element 508 and the single vibrating body 506 are configured such that the top vibrating tube 502 is supported above the support element 508 and the bottom vibrating tube 504 is suspended below the support element 508. The support element 508 may include a damping element 518, e.g., a set of springs and/or a set of elastomeric isolators, for damping the transmission of the vibrations to the support element 508.

As shown in FIG. 18, the vertical symmetrical vibrating mill 500 also defines a reference plane of symmetry 510 whereby the top vibrating tube 502 and the bottom vibrating tube 504 are located, e.g., symmetrically disposed, on opposite sides of the reference plane of symmetry 510. FIG. 18 illustrates that the top vibrating tube 502 is located above the reference plane of symmetry 510, while the bottom vibrating tube 504 is located below the reference plane of symmetry 510, and that the top vibrating tube 502 and the bottom vibrating tube 504 are substantially symmetrical with respect to each other about the reference plane of symmetry 510.

The vertical symmetrical vibrating mill 500 includes two pairs 514a, 514b of exciter elements 514 connected to the top vibrating tube 502, wherein the first pair 514a includes exciter elements 5141 and 5142 and the second pair 514b includes exciter elements 5143 and 5144. In addition, the vertical symmetrical vibrating mill 500 includes two pairs 514d, 514e of exciter elements connected to the bottom vibrating tube 504, wherein the first pair 514d includes exciter elements 5147 and 5148 and the second pair 514e includes exciter elements 5149 and 5150. Each one of the exciter elements 514 is configured to cause an excitation, e.g., a movement or vibration, in a direction or about an excitation axis that is substantially tangential to the vibrating tubes 502, 504.

FIG. 19 is a top view of the top vibrating tube 502 of the vertical symmetrical vibrating mill 500 shown in FIG. 21, taken along lines 19-19. FIG. 20 is a cross-sectional view of the bottom vibrating tube 504 of the vertical symmetrical vibrating mill 500 shown in FIG. 21, taken along lines 20-20. As shown in FIGS. 19 and 20, the vertical symmetrical vibrating mill 500 may be arranged such that each one of a pair of exciter elements 514 is spaced equidistantly relative to the other exciter element 514 of the pair, around the circumference of the respective vibrating tube 502, 504. For instance, referring to FIG. 19, in the pair 514a, the exciter elements 5141, 5142 are spaced equidistantly relative to each other around the circumference of the top vibrating tube 502, while in the pair 514b, the exciter elements 5143, 5144 are spaced equidistantly relative to each other around the circumference of the top vibrating tube 502.

In the embodiment shown in FIGS. 18 to 21, each pair of exciter elements 514 of the top vibrating tube 502 is misaligned circumferentially relative to the other pair of exciter element 514 of the top vibrating tube 502. For instance, the exciter elements 5141, 5142 of the pair 514a are misaligned circumferentially relative to the exciter elements 5143, 5144 of the pair 514b. Likewise, each pair of exciter elements 514 of the bottom vibrating tube 504 is misaligned circumferentially relative to the other pair of exciter element 514 of the bottom vibrating tube 504. For instance, the exciter elements 5147, 5148 of the pair 514d are misaligned circumferentially relative to the exciter elements 5149, 5150 of the pair 514e.

Furthermore, in FIGS. 18 to 21, corresponding pairs of exciter elements 514 of the top vibrating tube 502 and the bottom vibrating tube 504 are misaligned circumferentially relative to each other. For instance, the pair 514a of exciter elements 5141 and 5142 connected to the top vibrating tube 502 corresponds, e.g., by virtue of it being located on opposite sides of and an equal distance from the reference plane of symmetry 510, to the pair 514d of exciter elements 5147 and 5148 connected to the bottom vibrating tube 504. Around the circumference of the top vibrating tube 502, the exciter elements 5142 are circumferentially located at 90 and 270 degrees, respectively, while around the circumference of the bottom vibrating tube 504, the exciter elements 5147 and 5148 are each circumferentially located at 0 and 180 degrees, respectively. Likewise, around the circumference of the top vibrating tube 502, the exciter elements 5143 and 5144 are circumferentially located at 0 and 180 degrees, respectively, while around the circumference of the bottom vibrating tube 504, the exciter elements 5149 and 5150 are each circumferentially located at 90 and 270 degrees, respectively.

In one embodiment of the invention, the power supplied to each one of the exciter elements 514 corresponds to a distance between the exciter element 514 and the reference plane of symmetry 510. For instance, the power supplied to each one of the exciter elements 514 may be directly proportional to a distance between the exciter element 514 and the reference plane of symmetry 510.

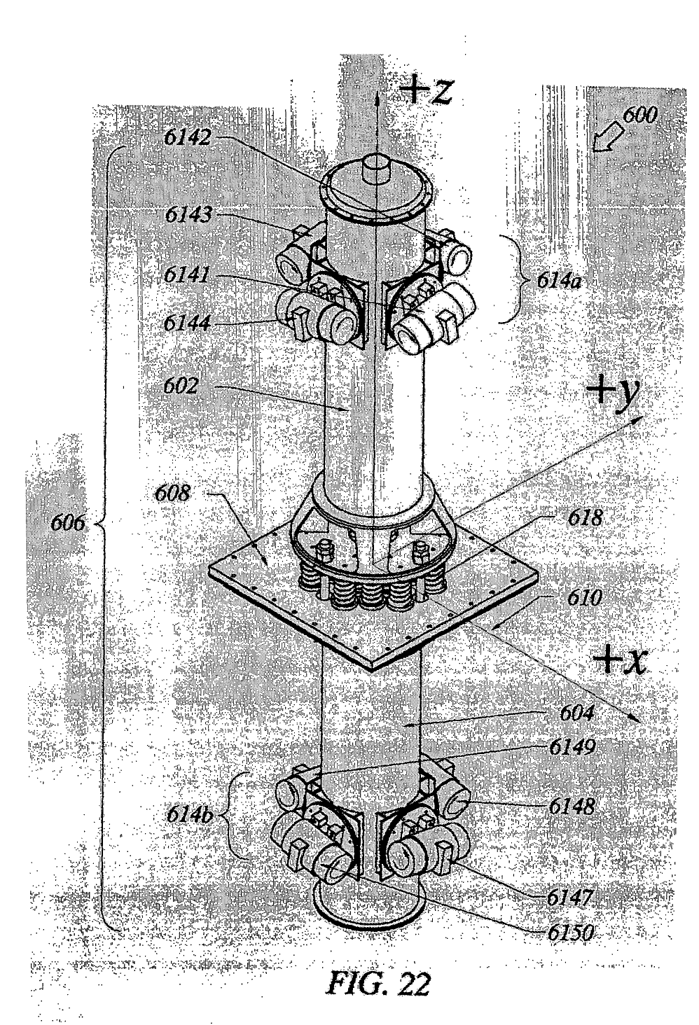

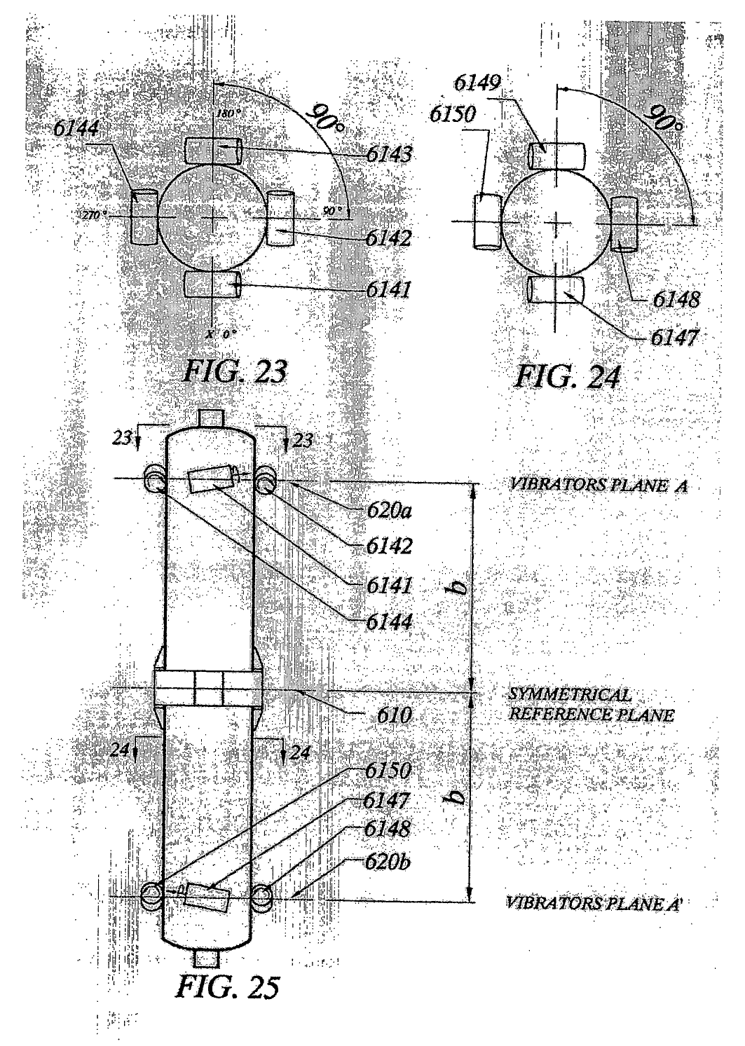

FIGS. 22 to 25 illustrate a vertical symmetrical vibrating mill in accordance with still another embodiment of the present invention. Specifically, FIG. 22 is a partial perspective view of a vertical symmetrical vibrating mill 600. FIG. 25, on the other hand, is a side view of the vertical symmetrical vibrating mill 600 illustrated in FIG. 22. The vertical symmetrical vibrating mill 600 includes a top vibrating tube 602 and a bottom vibrating tube 604 that are connected to each other so as to form a single vibrating body 606. The single vibrating body 606 is supported by a support element, such as the support element shown in FIG. 1, but which is shown in FIG. 22 only partially as support element 608. Advantageously, the support element 608 and the single vibrating body 606 are configured such that the top vibrating tube 602 is supported above the support element 608 and the bottom vibrating tube 604 is suspended below the support element 608. The support element 608 may include a damping element 618, e.g., a set of springs and/or a set of elastomeric isolators, for damping the transmission of the vibrations to the support element 608.

As shown in FIG. 22, the vertical symmetrical vibrating mill 600 also defines a reference plane of symmetry 610 whereby the top vibrating tube 602 and [symbol] vibrating tube 604 are located, e.g., symmetrically disposed, on opposite sides of the reference plane of symmetry 610. FIG. 22 illustrates that the top vibrating tube 602 is located above the reference plane of symmetry 610, while the bottom vibrating tube 604 is located below the reference plane of symmetry 610, and that the top vibrating tube 602 and the bottom vibrating tube 604 are substantially symmetrical with respect to each other about the reference plane of symmetry 610.

The vertical symmetrical vibrating mill 600 includes a set 614a of exciter elements 614 connected to the top vibrating tube 602, the set 614a including four exciter elements 6141, 6142, 6143 and 6144. Each exciter element of the set 614a is located in a plane 620a. In addition, the vertical symmetrical vibrating mill 600 includes a set 614b of exciter elements connected to the bottom vibrating tube 604, the set 614b including four exciter elements 6147, 6148, 6149 and 6150. Each exciter element of the set 614b is located in a plane 620b. Each one of the exciter elements 614 is configured to cause an excitation, e.g., a movement or vibration, in a direction or about an excitation axis that is substantially tangential to the vibrating tubes 602, 604.

FIG. 23 is a top view of the top vibrating tube 602 of the vertical symmetrical vibrating mill 600 shown in FIG. 25, taken along lines 23-23. FIG. 24 is a cross-sectional view of the bottom vibrating tube 604 of the vertical symmetrical vibrating mill 600 shown in FIG. 25, taken along lines 24-24. As shown in FIGS. 23 and 24, the vertical symmetrical vibrating mill 600 may be arranged such that each one of the exciter elements 614 in a particular set is spaced circumferentially equidistantly relative to the other exciter elements 614 in the set. For instance, referring to FIG. 23, in the set 614a, the exciter elements 6141, 6142, 6143 and 6144 are each spaced equidistantly, e.g., 90 degrees apart, relative to each other around the circumference of the top vibrating tube 602. Likewise, in the set 614b, the exciter elements 6147, 6148, 6149 and 6150 are each spaced equidistantly, e.g., 90 degrees apart, relative to each other around the circumference of the bottom vibrating tube 604.

In the embodiment shown in FIGS. 22 to 25, the exciter elements 614 of the top vibrating tube 602 and the bottom vibrating tube 604 are aligned circumferentially relative to each other. For instance, in the set 614a, the exciter elements 6141, 6142, 6143 and 6144 are circumferentially located around the top vibrating tube 602 at 0, 90, 180 and 270 degrees, respectively. Likewise, in the set 614b, the exciter elements 6147, 6148, 6149 and 6150 are circumferentially located around the bottom vibrating tube 604 at 0, 90, 180 and 270 degrees, respectively. It should be recognized that, in other embodiments, the exciter elements 614 of the top vibrating tube 602 and the bottom vibrating tube 604 may be misaligned circumferentially relative to each other.

In one embodiment of the invention, the power supplied to each one of the exciter elements 614 corresponds to a distance between the exciter element 614 and the reference plane of symmetry 610. For instance, the power supplied to each one of the exciter elements 614 may be directly proportional to a distance between the exciter element 614 and the reference plane of symmetry 610.

There are various power supply arrangements that may be employed in accordance with the present invention. As set forth more fully above, the power supplied to each one of the exciter elements, for instance 114, 214, etc., may correspond to, e.g., be directly proportional to, a distance between the exciter element and the reference plane of symmetry. FIG. 26 illustrates one power supply arrangement, in accordance with one embodiment of the present invention, for a vertical symmetrical vibrating mill 700 that employs electric motors, such as the electric motors 140 illustrated in FIG. 4, to actuate the exciter elements. For instance, electric motor 740a is employed to actuate the exciter element 7141. The electric motor, e.g., electric motor 740a, of each exciter element, e.g., exciter element 7141, is coupled to a respective variable speed drive unit 715, e.g., variable speed drive unit 715a. In addition, each electric motor 740, e.g., electric motor 740a, is coupled to a respective encoder unit 711, e.g., encoder unit 711a, which may be an inductor sensor. Each variable speed drive unit 715 is coupled to a controller (hereinafter “PLC”) 717. The PLC 717 is coupled to a power supply unit 719 717 is also coupled to a converter 721, which in turn is coupled to a user interface, e.g., computing device, 723. By this arrangement, the PLC 717 may be programmed, e.g., by a user of the computing device 723, to control, such as by a voltage, the variable speed drive units 715. In this manner, an amount of electric power supplied to each one of the exciter elements 714 is controlled so as to corresponds to, e.g., be directly proportional to, a distance between the exciter element 714 and the reference plane of symmetry 710. Furthermore, by this arrangement, the PLC 717 may be programmed to operate the variable speed drive units 715 so as to supply an equal amount of electric power to corresponding exciter elements 714, e.g., exciter elements 714 that are located on opposite sides of the reference plane of symmetry 710 and that are located an equal distance from the reference plane of symmetry 710. Data obtained by the encoders 711, e.g., speed of the electric motor 740, etc., may be provided to the PLC 717, which provides the data to the computing device 723 via converter 721. By this arrangement, the operation of the electric motors 740, including the synchronization of the electric motors 740, can be monitored via the user interface 723.

FIG. 27 illustrates another power supply arrangement, in accordance with one embodiment of the present invention, for a vertical symmetrical vibrating mill 800 that employs hydraulic motors to actuate the exciter elements. For instance, hydraulic motor 840a is employed to actuate the exciter element 8141. The hydraulic motor 840, e.g., hydraulic motor 840a, of each exciter element, e.g., exciter element 8141, is coupled to a respective proportional valve 815, e.g., proportional valve 815a. In addition, each hydraulic motor 840, e.g., hydraulic motor 840a, is coupled to a respective encoder unit 811, e.g., encoder unit 811a. Each proportional valve 815 is coupled to a hydraulic power supply unit 813. In addition, each proportional valve 815 is coupled to a controller (hereinafter “PLC”) 817. The PLC 817 is coupled to a power supply unit 819. The PLC 817 is also coupled to a converter 821, which in turn is coupled to a user interface 823. By this arrangement, the PLC 817 may be programmed, e.g., by a user of the computing device 823, to control, such as by a modulated voltage, the proportional valves 815. In this manner, an amount of hydraulic power supplied to each one of the exciter elements 814 mat be contr [symbol] to correspond to, e.g., be directly proportional to, a distance between the exciter element 814 and the reference plane of symmetry 810. Furthermore, by this arrangement, the PLC 817 may be programmed to control the proportional valves 815 so as to supply an equal amount of hydraulic power to corresponding exciter elements 814, e.g., exciter elements 814 that are located on opposite sides of the reference plane of symmetry 810 and that are located an equal distance from the reference plane of symmetry 810. Operating data obtained by the encoders 811 may be provided to the PLC 817, which provides the data to the computing device 823 via converter 821, such as for the purposes of monitoring the operation of the hydraulic motors 840.

FIG. 28 illustrates still another power supply arrangement, in accordance with one embodiment of the present invention, for a vertical symmetrical vibrating mill 900 that employs pneumatic motors to actuate the exciter elements. For instance, pneumatic motor 940a is employed to actuate the exciter element 9141. The pneumatic motor 940, e.g., pneumatic motor 940a, of each exciter element, e.g., exciter element 9141, is coupled to a respective proportional valve 915, e.g., proportional valve 915a. In addition, each pneumatic motor 940, e.g., pneumatic motor 940a, is coupled to a respective encoder unit 911, e.g., encoder unit 911a. Each proportional valve 915 is coupled to a pneumatic power supply unit 913, In addition, each proportional valve 915 is coupled to a controller (hereinafter “PLC”) 917. The PLC 917 is coupled to a power supply unit 919. The PLC 917 is also coupled to a converter 921, which in turn is coupled to a user interface 923. By this arrangement, the PLC 917 may be programmed, e.g., via the user interface 923, to control the proportional valves 915 so as to supply an amount of pneumatic power to each one of the exciter elements 914 that corresponds to, e.g., is directly proportional to, a distance between the exciter element 914 and the reference plane of symmetry 910. Furthermore, by this arrangement, the PLC 917 may be programmed to operate the proportional valves 915 so as to supply an equal amount of pneumatic power to corresponding exciter elements 914, e.g., exciter elements 914 that are located on opposite sides of the reference plane of symmetry 910 and that are located an equal distance from the reference plane of symmetry 910. Operating data obtai [symbol] encoders 911 may be provided to the PLC 917, which provides the data to the user interface 923 via converter 921, such as for the purposes of monitoring the operation of the pneumatic motors 940.

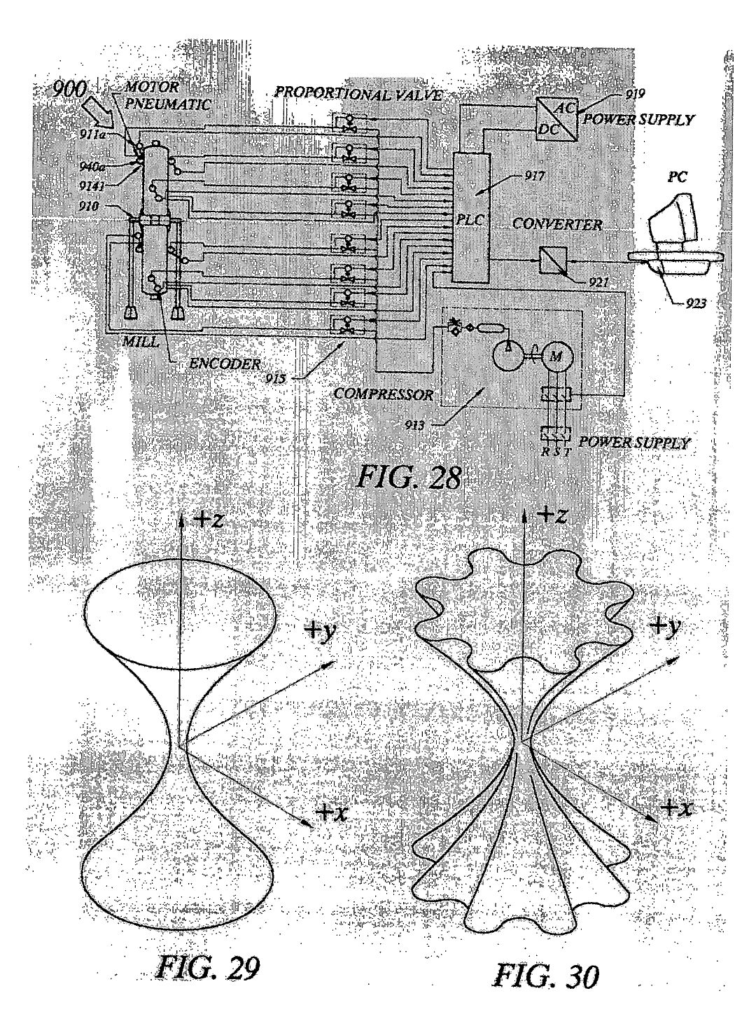

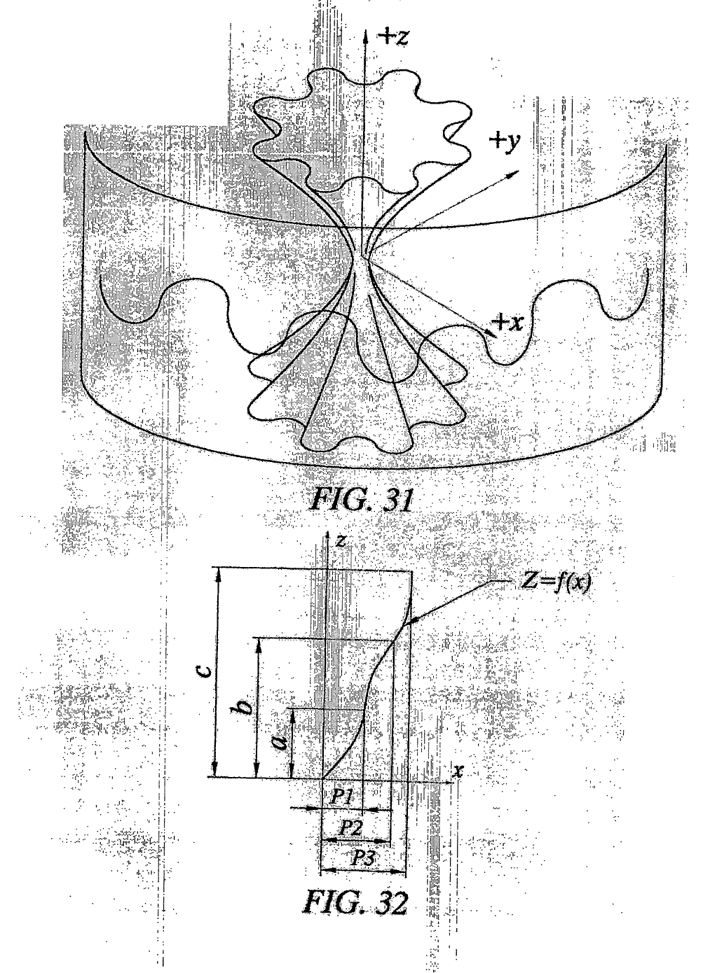

The present invention may improve the operation of vertical symmetrical vibrating mills by providing for vibration forces that are more evenly distributed over the vertical symmetrical vibrating mills. For instance, the distribution and the direction of the forces generated by the exciter elements may contribute to pendular movements that are distributed into displacements in the form of a cone. Furthermore, by controlling the operation of the exciter elements as set forth above, vibration forces are achieved which distribute energy with a higher efficiency. FIG. 29 is a diagram that illustrates a cone that is representative of a pendular distribution of constant frequency, e.g., when the exciter elements are operated so as to vibrate at a constant frequency. FIG. 30 is a diagram that illustrates a pseudo-cone that is representative of a pendular distribution of variable frequency, e.g., when the exciter elements are operated so as to vibrate at a variable frequency. In addition, FIG. 31 is a diagram that illustrates a pseudo-cone that is representative of a pendular distribution of variable frequency as shown in three planes, e.g., when the exciter elements are operated so as to vibrate at a variable frequency.

Several embodiments of the present invention are specifically illustrated and/or described herein. However, it will be appreciated that modifications and variations of the present invention are covered by the above-teachings without departing from the spirit and intended scope of the present invention.

What is claimed is:

1. A vertical symmetrical vibrating mill comprising:
a top vibrating tube and a bottom vibrating tube, the top vibrating tube and the bottom vibrating tube being connected so as to form a single vibrating body that is at least one of supported and suspended via a support element, wherein the top vibrating tube and the bottom vibrating tube are located on opposite sides of a reference plane of symmetry, and wherein the top vibrating tube and the bottom vibrating tube each have a common axis that is perpendicular to the reference plane of symmetry; and
a plurality of exciter elements including at least one exciter element connected to each of the top vibrating tube and the bottom vibrating tube, each one of the plurality of exciter elements configured to cause an excitation in a direction that is substantially tangential to the vibrating tubes, each one of the plurality of exciter elements configured to at least one revolve and oscillate at the same synchronized frequency, wherein an amount of power that is provided to each one of the exciter elements is proportional to a distance between the exciter element and the reference plane of symmetry.

2. The vibrating mill of claim 1, wherein the common axis of the top vibrating tube and the bottom vibrating tube is oriented in a direction corresponding to the direction of gravity.

3. The vibrating mill of claim 1, wherein the frequency at which each one of the plurality of exciter elements is configured to at least one revolve and oscillate is one of constant and variable.

4. The vibrating mill of claim 1, wherein each one of the exciter elements are connected laterally to one of the vibrating tubes.

5. The vibrating mill of claim 1, wherein the plurality of exciter elements are located so as to be grouped in pairs.

6. The vibrating mill of claim 5, wherein, in a pair of exciter ele [symbol] exciter elements are spaced equidistantly around the circumference of the respective vibrating tube.

7. The vibrating mill of claim 6, wherein, in a pair of exciter elements, the exciter elements are located in a plane that is parallel to the reference plane of symmetry.

8. The vibrating mill of claim 7, wherein a distance between the plane that includes a first pair of exciter elements connected to the top vibrating tube and the reference plane of symmetry is equal to a distance between the plane including a second pair of exciter elements connected to the bottom vibrating tube and the reference plane of symmetry.

9. The vibrating mill of claim 8, wherein an axis of rotation of the exciter elements of the top vibrating tube define an angle between 0° to 180° relative to the common axis of the top vibrating tube and the bottom vibrating tube.

10. The vibrating mill of claim 8, wherein an axis of rotation of the exciter elements of the bottom vibrating tube define an angle between 0° to 180° relative to the common axis of the top vibrating tube and the bottom vibrating tube.

11. The vibrating mill of claim 9, wherein each one of the exciter elements rotates in the same direction.

12. The vibrating mill of claim 10, wherein each one of the exciter elements rotates in the same direction.

13. The vibrating mill of claim 12, wherein the exciter elements of the top vibrating tube are configured to rotate in the same direction as the exciter elements of the bottom vibrating tube.

14. The vibrating mill of claim 12, wherein the exciter elements vibrating tube are configured to rotate in the opposite direction as the exciter elements of the bottom vibrating tube.

15. The vibrating mill of claim 1, wherein the vibrating tubes are dividable into two chambers.

16. The vibrating mill of claim 15, wherein each chamber has a grid to contain a grinding media.

17. The vibrating mill of claim 16, wherein the grid defines openings that are smaller than the smallest dimension of the grinding media.

18. The vibrating mill of claim 1, wherein the exciter elements operate electromagnetically.

19. The vibrating mill of claim 1, wherein the vibrators include eccentric counterweights.

20. The vibrating mill of claim 19, wherein the exciter elements are activated by an electric motor.

21. The vibrating mill of claim 20, wherein the exciter elements are activated by a motor situated internally with respect to the exciter element.

22. The vibrating mill of claim 20, wherein the exciter elements are activated by a motor situated externally with respect to the exciter element, the motor and the exciter elements coupled via a sliding element and a cardan joint.

23. The vibrating mill of claim 19, wherein the exciter elements are activated by a hydraulic motor.

24. The vibrating mill of claim 19, wherein the exciter elements are activated by pneumatic motors.

25. The vibrating mill of claim 1, wherein the support element is located at the reference plane of symmetry.

26. The vibrating mill of claim 25, wherein the support element is configured such that the top vibrating tube is supported above the reference plane of symmetry and the bottom vibrating tube is suspended below the reference plane of symmetry.

27. The vibrating mill of claim 1, wherein the support element includes at least one of a set of springs and a set of elastomeric isolators.

28. The vibrating mill of claim 18, wherein the exciter elements are electromagnetic vibrators.

29. The vibrating mill of claim 28; wherein the axis of oscillation of the exciter elements of the top and bottom vibrating tubes has an angle of inclination between 0° to 90°.

30. The vibrating mill of claim 28, wherein the exciter elements of the top vibrating tube are aligned relative to the exciter elements of the bottom vibrating tube.

31. The vibrating mill of claim 28, wherein the exciter elements of the top vibrating tube are misaligned relative to the exciter elements of the bottom vibrating tube.

32. The vibrating mill of claim 8, wherein the power of the exciter elements in each plane that includes the first pair of exciter elements and the second pair of exciter elements is directly proportional to the distance between the plane and the refer [symbol] of symmetry.

33. The vibrating mill of claim 20, wherein the electrically-driven exciter elements are operated via variable speed drive units controlled by a controller device.

34. The vibrating mill of claim 33, wherein the controller device is a programmable logic controller.

35. The vibrating mill of claim 33, wherein the controller device is coupled to a user interface for at least one of providing data to the controller device and for receiving operating data for display to a user.

36. The vibrating mill of claim 35, wherein the operating data is generated by an encoder.

37. The vibrating mill of claim 23, wherein the hydraulically-driven exciter elements are operated via proportional valves connected to a hydraulic power supply, the proportional valves being controlled by a controller device.

38. The vibrating mill of claim 37, wherein the controller device is a programmable logic controller.

39. The vibrating mill of claim 37, wherein the controller device is coupled to a user interface for at least one of providing data to the controller device and for receiving operating data for display to a user.

40. The vibrating mill of claim 39, wherein the operating data is generated by an encoder.

41. The vibrating mill of claim 24, wherein the pneumatically-dri [symbol] elements are operated via proportional valves connected to a pneumatic power supply, the proportional valves being controlled by a controller device.

42. The vibrating mill of claim 41, wherein the controller device is a programmable logic controller.

43. The vibrating mill of claim 41, wherein the controller device is coupled to a user interface for at least one of providing data to the controller device and for receiving operating data for display to a user.

44. The vibrating mill of claim 43, wherein the operating data is generated by an encoder.

45. A method for grinding a substance, comprising the steps of:
providing a vertical symmetrical vibrating mill, the vertical symmetrical vibrating mill including a top vibrating tube and a bottom vibrating tube, the top vibrating tube and the bottom vibrating tube being connected so as to form a single vibrating body that is at least one of supported and suspended via a support element, wherein the top vibrating tube and the bottom vibrating tube are located on opposite sides of a reference plane of symmetry, and wherein the top vibrating tube and the bottom vibrating tube each have a common axis that is perpendicular to the reference plane of symmetry, the vertical symmetrical vibrating mill also including a plurality of exciter elements including at least one exciter element connected to each of the top vibrating tube and the bottom vibrating tube, each one of the plurality of exciter elements configured to cause an excitation in a direction that is substantially tangential to the vibrating tubes, each one of the plurality of exciter elements configured to at least one revolve and oscillate at the same synchronized frequency;
placing the substance into at least one of the top vibrating tube and the bottom vibrating tube;
exciting the plurality of exciter elements by providing an amount [symbol] each one of the exciter elements that is proportional to a distance between the exciter element and the reference plane of symmetry such that grinding media stored in the at least one of the top vibrating tube and the bottom vibrating tube grinds the substance.

46. The method of claim 45, further comprising the step of positioning the vertical symmetrical vibrating mill such that the common axis of the top vibrating tube and the bottom vibrating tube is oriented in a direction corresponding to the direction of gravity.

47. The method of claim 45, further comprising the step of at least one revolving and oscillating of the plurality of exciter elements at a frequency which is one of constant and variable.

48. The method of claim 45, further comprising the step of connecting each one of the exciter elements laterally to one of the vibrating tubes.

49. The method of claim 45, wherein pairs of the exciter elements are located in a plane that is parallel to the reference plane of symmetry.

50. The method of claim 49, wherein a distance between the plane that includes a first pair of exciter elements connected to the top vibrating tube and the reference plane of symmetry is equal to a distance between the plane including a second pair of exciter elements connected to the bottom vibrating tube and the reference plane of symmetry.
